(19) United States
(12) Patent Application Publication
(10) Pub. No.: US 2012/0215673 A1
(43) Pub. Date: Aug. 23, 2012

(54) ELECTRONIC TRADING SYSTEMS AND METHODS

(76) Inventors: Bruce Usher, New York, NY (US); Barry Witkow, Encino, CA (US); Douglas G. Huntington, Calabasas, CA (US)

(21) Appl. No.: 13/453,972

(22) Filed: Apr. 23, 2012

Related U.S. Application Data
(63) Continuation of application No. 09/858,844, filed on May 16, 2001.
(60) Provisional application No. 60/205,138, filed on May 18, 2000.

(51) Int. Cl. G06Q 40/04

(52) U.S. Cl. 705/37

(57) ABSTRACT

Electronic trading systems and methods provide users with the opportunity to trade financial instruments such as equities, foreign exchange, bonds, and swaps. Swaps may be defined using specialized electronic swap term sheets. A user who proposes a swap may select other users and invite them to bid on the swap. The system may initiate an auction for a proposed swap. Bidding users may bid until the swap auction is complete. The swap may be confirmed, and swap terms downloaded to a user's risk management or back office software.

This application claims the benefit of U.S. Provisional Patent Application No. 60/205,138, filed May 18, 2000.

### BACKGROUND OF THE INVENTION

This invention relates to systems and methods for electronic trading. More particularly, this invention relates to electronic trading systems and methods that provide for the trading of financial instruments such as stocks, bonds, swaps, interest rate agreements, and other financial instruments.

Swaps are financial contracts executed between two parties in which one party exchanges future cash flows with the other party. For example, one party can exchange a payment based on a fixed interest rate for a payment based on a variable interest rate. Swaps are frequently employed by parties to manage the interest rate and currency risk exposure of their portfolios. A party may propose a swap to a counter party by, for example, specifying a principal amount commonly referred to as the notional amount, an interest rate the party wishes to receive (e.g., available rate), the duration of the swap, and other swap terms. The counter party may then propose, and the parties may negotiate, the rate (e.g., a fixed rate) that the first party is going to pay on the notional amount.

Swap users, such as corporations or financial firms, typically obtain the best swap rate by calling a select group of approved swap dealers and requesting that they bid on a swap. Swap dealers, such as commercial banks and investment banks, bid by proposing an interest rate they are willing to accept (i.e., that the swap user pays), based on the terms of the swap. Swap dealers are generally approved by the swap users based on the basis of credit lines established between the swap user and the swap dealers. Swap users usually call two to six swap dealers to bid on a swap, and typically try to negotiate a transaction simultaneously with the dealers over the telephone by describing the terms of the swap. After two parties agree on a swap, the parties may exchange a written confirmation. The written confirmation may confirm the terms of the swap. Typically, once the confirmation is signed by both parties, the swap becomes a binding agreement (i.e., a binding exchange of promises to make payments).

The conventional swap bidding process is deficient in a number of respects. The number of dealers that a user can contact may be limited by time and other constraints. The communications process between the swap user and the dealers is time consuming and prone to causing errors in transaction terms or credit lines. Processing transaction terms, such as with a portfolio management system, must be performed separately from the negotiation once the parties agree to a swap. In addition, the conventional swap bidding process does not allow swap users to run true auctions in which dealers openly compete against one another to obtain the swap by bidding the best bid. While dealers may be put into competition with one another over the telephone, without an “open” bidding environment there is no price discovery mechanism to provide dealers with information that will encourage them to improve their bids. This “closed” bidding environment often results in dealers not giving their best bids because dealers are typically concerned about the “winners curse”—that they win the swap by overpaying.

It would be desirable, therefore, to provide an electronic trading system that provides system users with opportunities to electronically auction swaps using an open auction.

It would also be desirable to provide an on-line trading system that provides system users with opportunities to electronically auction swaps over the Internet or other electronic network using an open auction.

It would also be desirable to provide an electronic trading system that provides for the open bidding for swaps.

It would also be desirable to provide an on-line trading system that provides for the open bidding for swaps over the Internet.

It would also be desirable to provide an electronic trading system that provides for proxy bidding for swaps.

It would also be desirable to provide an on-line trading system that provides for proxy bidding for swaps over the Internet.

It would also be desirable to provide an electronic trading system that provides electronic term sheets that are specialized for use by system users.

It would also be desirable to provide an on-line trading system that provides electronic term sheet pages that are specialized for use by system users.

### SUMMARY OF THE INVENTION

It is therefore an object of some embodiments of the present invention to provide users with opportunities to electronically auction swaps using an open auction.

It is an object of some embodiments of the present invention to provide users with opportunities to electronically auction swaps over the Internet using an open auction.

It is an object of some embodiments of the present invention to provide for the open bidding for swaps.

It is an object of some embodiments of the present invention to provide for the open bidding for swaps over the Internet.

It is an object of some embodiments of the present invention to provide for proxy bidding for swaps.

It is an object of some embodiments of the present invention to provide for proxy bidding for swaps over the Internet.

It is an object of some embodiments of the present invention to provide electronic term sheets that are specialized for use by users.

It is an object of some embodiments of the present invention to provide electronic term sheet pages that are specialized for use by users.

Various embodiments and features of the present invention are described, for example, in U.S. Provisional Patent Application No. 60/205,138, filed May 18, 2000, which is hereby incorporated by reference herein in its entirety.

In accordance with the principles of the present invention, systems and methods for electronic trading are provided. Some embodiments of the present invention may provide system users (e.g., swap users and swap dealers), sometimes referred to herein as “a user” or “users,” with opportunities to post offers for swaps using any suitable approach. Some embodiments may, for example, provide a user with an opportunity to indicate the type of product the user desires to post an offer for. The user may indicate a desire to, for example, post an offer for domestic or foreign swaps, floors, ceilings, collars, or other products. Some embodiments may also provide a user with an opportunity to indicate the user's position in the swap. The user may indicate, for example, that the user wishes to pay or receive fixed rate payments, pay or receive variable rate payments, pay or receive equity-index-based payments, or any other position. The user may also indicate the interest rate that the user wishes to receive or pay, or the equity index on which payments are based. In currency swaps, the user may also indicate the user's currency and the currency the user wishes to trade for.

Some embodiments of the present invention may auction swaps using any suitable style auction. Some embodiments may, for example, provide for standard open English-style auctions in which bidders bid on swaps until the best bid wins. If desired, some embodiments may allow bidders to see other bids while keeping the other bidders' identities secret. This approach may have the advantage of fostering aggressive and competitive bidding while still providing for the privacy of the system users. Some users may find the possibility of having their bidding practices monitored undesirable. Some embodiments may provide for closed auctions and for trading swaps using limit orders. When a swap offer is posted by a user as a limit order, the first user to bid a stated interest rate, the “limit” rate, is the winner of the proposed swap. Some embodiments may auction swaps using, for example, a Dutch-style auction. Users may, for example, offer a swap at a particular notional amount. Other users may bid, specifying only a portion of the notional amount. Bids may be accepted until the entire notional amount is gone. Any other suitable style of auction may be used.

Electronic business-to-business trading of swaps may provide a number of advantages to users. Swap users, such as corporations or financial firms, may receive more competitive and aggressive bids for proposed swaps because bidders have access to other bids. Swap users may also realize efficiency gains by being able to invite larger numbers of swap dealers to bid for proposed swaps than previously feasible. Virtually error-free communications of trade details may be provided because every detail of swap terms are transmitted to all dealers electronically. In addition, swap terms can be downloaded to the users' risk management or back office systems, eliminating the time consuming step of converting traditional voice trades to data storage.

Swap dealers, such as commercial banks and investment banks, may also realize a number of benefits from such an electronic trading system. In some embodiments, swap dealers that participate in an electronic system are automatically marketed to system users as potential bidders on each swap. This may tend to reduce the cost of dealer marketing. For example, dealers may post research and trade ideas on the system which can be viewed only by some but not all users of the system, as predetermined by the dealers posting such information. In addition, the system may tend to provide swap dealers with an increased trading flow. This may tend to aid in maintaining a hedged swap book. That is, dealers currently offset most of the risk of their swap portfolios by taking offsetting positions with other dealers. Much of swap trading is therefore inter-dealer. Some embodiments may provide dealers with opportunities to deal additional swaps by dealing with additional swap users, thereby increasing the dealers' trade flow and ability to offset the risk of their portfolios. Some embodiments may also provide participating dealers with precise, unbiased information on where swaps are trading and in what volume. This price information may be extremely valuable to swap dealers for the value of their swap books. Swap dealers may also realize the benefits of the increased accuracy of electronic swap offers and the advantages of straight-through processing of swaps by the dealers' risk management or back office systems.

Some embodiments may provide users with opportunities to post offers for swaps using any suitable approach. Some embodiments may, for example, provide a user with an opportunity to select the type of product or products that the user wishes to post an offer for. In response to the user indicating a type of product or products, they may be provided with an electronic term sheet into which the user may enter the terms of a swap. If desired, some embodiments may provide an electronic term sheet that is specialized to the indicated product, the user, or a combination thereof. Some users, for example, may only deal with particular interest rates (e.g., LIBOR) or equity indexes (e.g., the Dow Jones Industrial Average (DJIA)). Their term sheets may be specialized to provide the users with an opportunity to select only those interest rates or indexes the users are interested in. Specialization of term sheets may be accomplished using any suitable approach. A system provider may, for example, interview each system user, determine each user's preferences, and generate electronic term sheets accordingly. Alternatively, some embodiments may provide users with opportunities to specialize their own term sheets.

Some embodiments may provide a user with an opportunity to indicate a counter party user or counter party user that the user wishes to invite to bid on a proposed swap. Some embodiments may invite the indicated users sometimes referred to herein as “invitees,” to bid on the swap using any suitable approach. Some embodiments may, for example, invite users by providing messages via electronic notification (e.g., e-mail), by automatically calling or paging the dealers, or by using any other suitable approach. Users may participate in auctions for swaps by, for example, selecting a link in the system message or e-mail, or by logging onto the system and selecting an offer from a pending offer list.

Users may participate in auctions by placing bids on the proposed swap. Some embodiments may, for example, provide a user with opportunities to enter bids, beat the current best bid, to proxy bid, and to retract the user's last bid. Some embodiments may provide swap terms and current bids to the user's risk management or back office system. The risk management of back office system may calculate a bid using suitable modeling and forecasting techniques. The risk management or back office system may electronically provide the bid to the trading system. This may occur, for example, automatically or each time a bid is placed, and until the user's maximum bid is reached. In another approach, the systems may calculate bids and present them to the user. The user may manually place the bid if desired. Some embodiments may complete an auction when, for example, a posting user (i.e., the user who posted the swap) accepts a bid, when there are no bids for a predetermined period of time, at a particular time, or in response any other suitable event. Whether or not the best bid and the posted offer constitute a binding agreement may depend on the business rules underlying the system. In practice, the business rules of a particular embodiment may be provided for in a separate agreement that is signed by all users before entering into swaps. In one approach, the completion of the auction may be a binding agreement between the best-bidder and the posting user. In another suitable approach, the winning bidder and the posting user may be provided with an opportunity to confirm the terms of the swap and complete the swap. In this approach, the confirmation of the terms may complete a binding agreement. Confirmation may occur by signing a printed confirmation, by electronically signing an electronic confirmation, or by both parties indicating an acceptance using some other electronic approach. Any other suitable approach for completing a swap may be used.

Once an auction has been completed, and a swap completed according to the applicable business rules of a system, some embodiments may provide for the electronic transmission of the swap terms to the risk management or back office systems of the parties. This information may be used by the risk management or back office systems of the parties to provide the parties with information useful, for example, in deciding whether to make additional swaps. Some embodiments or a system to which an embodiment has downloaded swap terms, may provide for the electronic exchange of funds pursuant to the terms of the swaps.

Some features of this invention may be applied to trading other financial instruments such as, for example, stocks, bonds, shares in mutual funds, options, or other equities, debt instruments, derivatives, or any other suitable financial asset or liability. Some embodiments may, for example, provide users with opportunities to specialize term sheets for any trade of any suitable financial instrument. Some embodiments may allow for bidding by, for example, placing market orders, limit orders, or any other type of bid. Some embodiments may also allow users to specify the invitees of a trade, notify the invitees that they are invited, and allow the invitees to participate in the trade. Invitees may participate using any suitable approach. They may, for example, place bids on stocks, bonds, mutual funds, or other financial instruments. Some embodiments may allow for bids in an auction, and allow the users to bid on financial instruments by proxy, as described herein or using any other suitable approach. Once trades are complete (e.g., when a user accepts a bid, when the best bid is placed in an auction, etc.), some embodiments may allow users to confirm the trades, may generate trade documentation, and may provide trade information electronically to the user's risk management or back office systems. During trades, some embodiments may provide current bids and offers to the risk management or back office systems. The back office or risk management systems may automatically determine a bid for a given user, using suitable modeling and forecasting techniques. The back office or risk management systems may automatically provide the bid to a trading system, or may present the price to the user so that the user may place the bid manually.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1a and 1b show illustrative on-line and non-on-line arrangements for a derivatives trading system, in accordance with two embodiments of the present invention;

FIG. 2 shows an illustrative arrangement for the access devices of FIG. 1a, in accordance with one embodiment of the present invention;

FIG. 3 shows a generalized flowchart of steps involved in operating the electronic trading system of FIGS. 1a and 1b, in accordance with one embodiment of the present invention;

FIG. 4 shows a flowchart of illustrative steps involved in posting swap offers, in accordance with one embodiment of the present invention;

FIG. 5 shows a flowchart of illustrative steps involved in providing users with opportunities to participate in swap auctions, in accordance with one embodiment of the present invention;

FIG. 6 shows an illustrative login page, in accordance with one embodiment of the present invention;

FIG. 7 shows an illustrative offer selection page, in accordance with one embodiment of the present invention;

FIGS. 8a and 8b show an illustrative term sheet page for United States Dollar (USD) interest rate swaps, in accordance with one embodiment of the present invention;

FIG. 9 shows an illustrative term sheet page for caps, floors, and collars, in accordance with one embodiment of the present invention;

FIGS. 10a and 10b show an illustrative term sheet page for non-USD interest rate swaps, in accordance with one embodiment of the present invention;

FIG. 11 shows an illustrative term sheet for currency swaps, in accordance with one embodiment of the present invention;

FIG. 12 shows an illustrative invitee page, in accordance with one embodiment of the present invention;

FIG. 13 shows an illustrative auction parameters page, in accordance with one embodiment of the present invention;

FIGS. 14a and 14b show an illustrative confirmation page, in accordance with one embodiment of the present invention;

FIG. 15 shows an illustrative offer list page, in accordance with one embodiment of the present invention;

FIG. 16 shows an illustrative swap user auction page, in accordance with one embodiment of the present invention;

FIGS. 17 and 18 show illustrative swap dealer open-auction pages, in accordance with one embodiment of the present invention; and

FIG. 19 shows an illustrative user configuration page, in accordance with one embodiment of the present invention.

### DETAILED DESCRIPTION OF ILLUSTRATIVE EMBODIMENTS

As used herein, “swap” and “swaps” are intended to include any type of arrangement in which parties agree to exchange periodic payments. Swaps may include, for example, interest rate-interest rate swaps, equity swaps, currency swaps, zero-coupon swaps, basis-rate swaps, caps, floors, collars, or any other type of swap or swap related product. In interest rate-interest rate swaps, also sometimes referred to herein as interest rate swaps, counterparties swap payments based on an interest rate. In equity swaps, both parties exchange payments based on some equity index. In currency swaps, counterparties agree to swap payments based on different currencies (e.g., United States Dollar for French Franc). In zero-coupon swaps, a fixed-rate payer is not required to make payments until the term for the swap is over, commonly referred to as the “maturity date” of the swap. In basis-rate swaps, parties exchange floating-rate payments based on different floating interest rate standards. For example, one party may make payments based on a particular U.S. Treasury security rate (e.g., the 3-month, 6-month, 1-year, 5-year, 7-year, 10-year, 20-year, or 30-year rate), while another makes payments based on the London Interbank Offered Rate (LIBOR).

Caps, floor, and collars are additional types of swaps that are sometimes referred to as interest rate agreements. In these types of swaps, one party, for an up front premium, agrees to compensate the other party when a designated interest rate, commonly referred to as the reference rate, is above or below a predetermined level. This predetermined level is commonly referred to as the “strike.” In caps, a party agrees to make payments when the reference rate rises above the strike. In floors, a party agrees to make payments when the reference rate falls below the strike. Caps and floors can be combined to form collars. A party may, for example, simultaneously purchase an interest rate cap (i.e., purchase a promise to receive payments when the reference rate rises above the strike) and sell an interest rate floor (i.e., sell a promise to make payments when the reference rate falls below the strike).

In each of these swaps, payments are based on an interest rate or index as applied to a principal amount, or a principal amount of currency, commonly referred to as the notional amount. Swaps may be generic, amortizing, accreting, or roller-coaster swaps. In generic swaps, sometimes referred to as bullet swaps, the notional amount does not vary over the term fo the swap. In amortizing swaps, the notional amount decreases in a predetermined way over the term of the swap the life of the swap. In accreting swaps, the notional amount increases in a predetermined way over the term of the swap. In roller-coaster swaps, the notional amount may rise or fall from period to period depending on, for example, a party's liability structure. Any other suitable approach of modifying the notional amount of a swap may be provided for.

Swaps are frequently employed by parties to manage the interest rate and currency risk exposure of their portfolios. For example, Bank A may receive deposits from depositors. In return, Bank A promises to pay the depositors interest at a fixed rate. These promises may be referred to as fixed rate liabilities of the bank. Liabilities may also be variable or floating. Bank A may then lend money to others at a floating or variable interest rate to pay the interest on the deposits and earn additional funds. The loans from the bank may be referred to as the bank's floating rate assets. Assets may also be fixed rate. Stated simply, the bank makes money when, in this example, the floating rate of the bank's assets is greater that the fixed rate of the bank's liabilities plus the bank's overhead. In this example, interest rate risk is the risk to Bank A that interest rates are going to fall. If interest rates fall enough, Bank A may pay more in interest on its liabilities than it receives on its assets. Bank A may attempt to minimize this interest rate risk by swapping a portion of its variable rate assets for fixed rate payments from another party.

The use of swaps to offset interest rate risk is shown in the following example of an interest rate-interest rate swap. Assume Bank A raises $50 Million from its depositors in exchange for a promise to the depositors that Bank A will pay interest for the use of the deposits. In this example, Bank A agrees to pay a fixed interest rate of 8% to the depositors for the use of their deposits. Bank A then lends the $50 Million it received to Corporation B for a period of five years. In exchange for the $50 Million, Corporation B agrees to pay a variable interest rate based on the London interbank offered rate (LIBOR) plus 2%. Assuming LIBOR is 8%, Corporation B will pay 10% in interest during the first year of the loan to Bank A. Bank A therefore earns the difference between the income on the loan from Corporation B (i.e., 10%) and the liability to the depositors (i.e., 8%), or 2% of $50 Million. If LIBOR declines to below 6%, the interest rate for the loan to Corporation B that year will be less than the interest rate Bank A must pay to its depositors. Thus, Bank A would lose money. This is Bank A's interest rate risk.

Assume Bank C was willing to enter into an interest rate swap with Bank A with the following terms: (1) the term of the swap would be five years and the amount of the swap, commonly referred to as its “notional amount,” would be $50 Million; (2) each year Bank C will pay Bank A 7% of $50 Million; and (3) each year Bank A will pay Bank C LIBOR plus 0.5% on the $50 Million notional amount. Each year, the effect of the swap coupled with the interest rate that Bank A must pay its depositors is as follows: (1) Bank A pays LIBOR plus 0.5% to Bank C but earns LIBOR plus 2% from Corporation B, resulting in a net inflow of 1.5% of $50 Million to Bank A; and (2) BANK C pays Bank A 7% of $50 Million and Bank A pays its depositors 8% of $50 Million, resulting in a net outflow from Bank A of 1%. Thus, Bank A earns 0.5% (or 50 basis points (bps)) of $50 Million regardless of whether LIBOR increases or decreases, effectively eliminating any interest rate risk characteristic of the bank's portfolio.

In practice, when a swap user desires to pay a fixed interest rate, the swap user is commonly said to solicit “offers” from swap dealers. When a swap user desires to receive a fixed rate, the swap user is said to solicit “bids” from swap dealers. For purposes of clarity, the terms “bid” and “bids” as used herein are intended to include offers, bids, or any combination thereof, as used in practice and for any type of system user whether swap user, swap dealer or other trader of financial instruments. The term “bids” may also include any other suitable bid or offer on any other financial instrument (e.g., stocks, bonds, mutual funds, etc.) The solicitation fo bids is sometimes referred to herein as posting an “offer.”

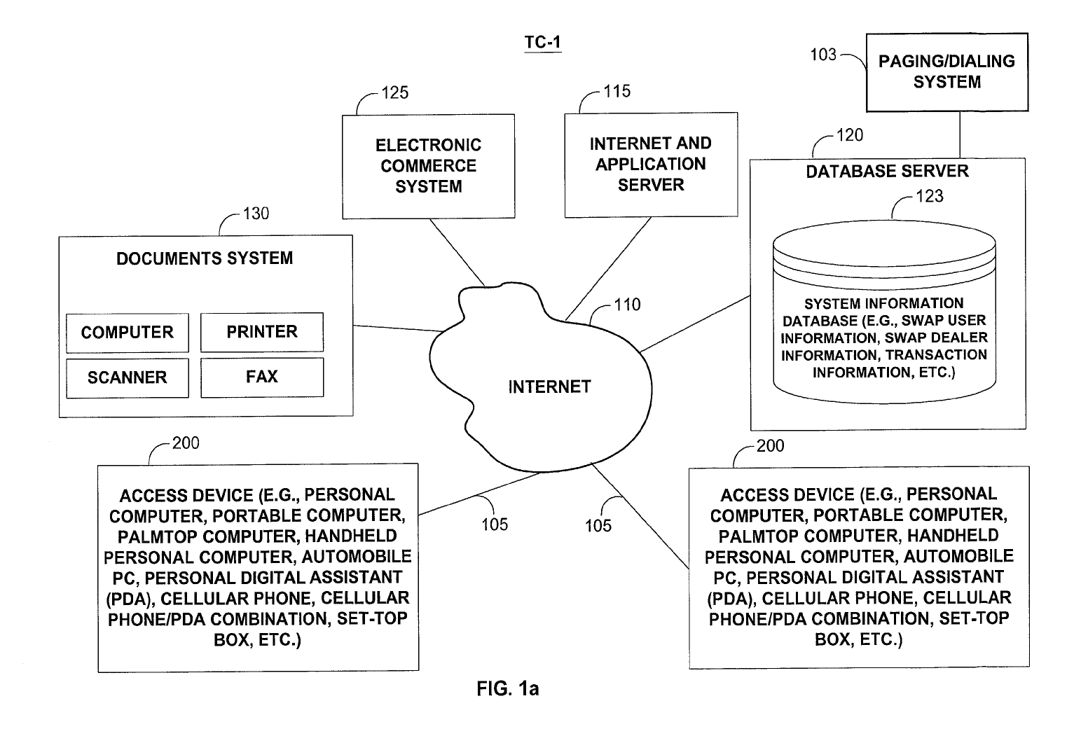

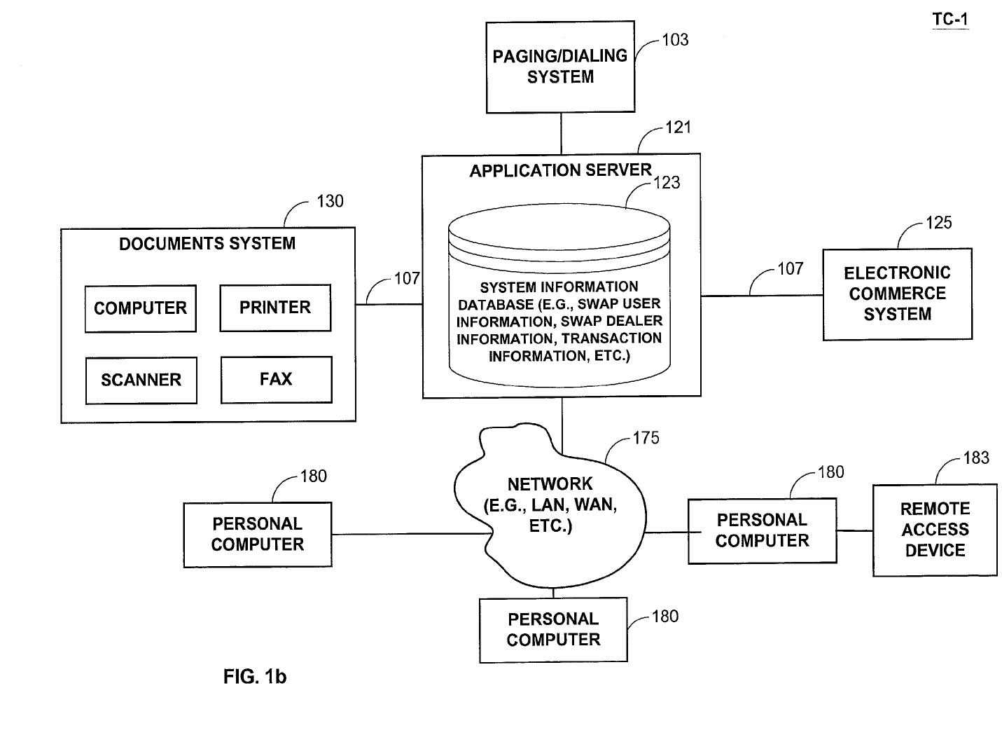

An electronic trading system in accordance with principles of the present invention may be implemented using, for example, a non-on-line (i.e., traditional client/server) approach or, preferably, using an on-line approach. If desired, a combination of these approaches may be used. Illustrative on-line and non-on-line based arrangements for an electronic trading system are shown in FIGS. 1a and 1b, respectively. In the illustrative on-line arrangement of FIG. 1a, access devices 200 may be connected via links 105 to Internet 110. Access devices 200 may include any device or combination of devices suitable for providing Internet access to users of the trading system. Access devices 200 may include, for example, any suitable personal computer (PC), portable computer (e.g., a notebook computer), palmtop computer, handheld personal computer (H/PC), automobile PC, personal digital assistant (PDA), Internet-enabled cellular phone, combined cellular phone and PDA, set-top box (e.g., a Web TV enabled set-top box), e-book, or any other device suitable for providing Internet access.

Internet server 115 may be any server suitable for providing users with on-line access to the trading system (e.g., a web server). Internet server 115 may, for example, run Windows NT 4.0 Enterprise Edition and Microsoft's Internet Information Server. Internet server 115 may, for example, provide one or more pages to access devices 200 using one or more suitable protocols (e.g., the HyperText Transfer Protocol (HTTP) and Transmission Control Protocol/Internet Protocol (TCP/IP)). For security purposes, Secure HTTP (HTTPS) and Secure Sockets Layer (SSL) protocols may be used to exchange pages. Digital certificates may also be used, such as digital certificates by Verisign, Inc. of Mountain View, Calif., USA. If desired, total solutions approaches such as Microsoft's Distributed Network Architectural Financial Services (DNAfs) may be used. Pages may be defined using, for example, any suitable markup language (e.g., Standard Generalized Markup Language (SGML), HyperText Markup Language (HTML), Dynamic HyperText Markup Language (DHTML), or any other suitable markup language or protocol for defining markup language documents). The pages may include scripts, computer code, or subsets of computer code, that define mini-programs (e.g., Java applets). If desired, secure MIME (S/MIME) may be used to provide e-mail invitations and confirmations to users. Any suitable protocol and record definition scheme may be used to transfer financial data such as, for example, the Extensible Markup Language (XML), Financial Product Markup Language (FPML), Financial Information Exchange Markup Language (FIXML), the Network Trade Model (NTM), or any other suitable language or protocol.

Links 105 may include any transmission medium suitable for providing Internet access to access devices 200. Links 105 may include, for example, a dial-up telephone line, a computer network or Internet link, an infrared link, a radio frequency link, a satellite link, a digital subscriber line link (e.g., a DSL link), a cable modem link, any other suitable transmission link or suitable combination of such links. Different links 105 may be of different types depending on, for example, the particular type of Internet access device 200.

Any protocol or combination of protocols suitable for supporting communications between access devices 200 and Internet and application server 115 over links 105 based on the particular device 200 and link 105 may be used. For example, Ethernet, Token Ring, Fiber Distributed Data Interface (FDDI), Circuit-Switched Cellular (CSC), Cellular Digital Packet Data (CDPD), RAM mobile data, Global System for Mobile communications (GSM), time division multiple access (TDMA), code division multiple access (CDMA), serial line Internet protocol (SLIP), point to point protocol (PPP), Transmission Control Protocol/Internet Protocol (TCP/IP), Sequenced Packet Exchange and Internetwork Packet Exchange (SPX/FPX) protocols, or any other suitable protocol or combination of protocols may be used.

Database server 120 may run any suitable database engine, such as, for example, Microsoft SQL Server V.7.0. Database server 120 may maintain a database or databases, suitable to the database engine used, of system information. System information may include, for example, information regarding users of the system (i.e., swap user and swap dealer information), pending swap transactions, and any other suitable information. User information may include, for example, user names, telephone numbers, addresses, company information, account information, credit line information, any other information suitable to the system for performing system functions, or any suitable combination thereof. User information may also include, for example, swap terms that the system may use to provide specialized electronic term sheets to the users. Swap transaction information may include any swap terms, bids, bidding parties, or any other suitable information.

Internet and application server 115 may retrieve system information from or provide system information to database server 120 using any suitable approach. Internet and application server 115 may, for example, have one or more common gateway interface (CGI) or Active Server Page (ASP) scripts for providing information submitted to Internet and application server 115 from database server 120 to access device 200, or for providing information submitted by access devices 200 to database server 120. One or more processes on Internet server 115 may, for example, generate SQL requests and provide the requests to a SQL server engine running on database server 120 for processing. Application server 120 may obtain data for the requests and provide the data to Internet and application server 115. Internet and application server 115 may format the data into web pages and provide the web pages to access devices 200.

In another approach, Internet and application server 115 may, for example, invoke remote procedures that reside on database server 120 using one or more remote procedure calls. Database server 120 may execute, for example, SQL statements for such invoked remote procedures. In still another suitable approach, objects executed by Internet and application server 115 may communicate with objects executed by database server 120 using, for example, an object request broker (ORB). This may involve using, for example, Microsoft's Distributed Component Object Model (DOOM) approach. Any other suitable scheme may be used. FIG. 1a shows Internet and application server 115 and database server 120 as separate servers. In practice, all or part of the functionality of the two servers may be combined into a single server or shared by the servers.

Internet and application server 115 or database server 120 may run one or more processes suitable for providing real-time auctions for swaps. Any suitable process or processes may be used. For example, Internet and application server 115 may run an auction engine or package, such as the Dynamic Pricing Toolkit sold by Open Site Technologies of Research Triangle, North Carolina, USA.

Database server 120 and access devices 200 may be connected to electronic commerce system 125, documents system 130, paging/dialing system 103, or a suitable combination thereof, via Internet 210. Alternatively, database server 120 may be connected to these systems via a local area network, wide area network, or other link or combination of links (not shown). FIG. 1a shows these systems as being separate from database server 120. In practice the functions of database server 120, Internet and application server 115, and one or more of these systems may be integrated into a single system.

Electronic commerce system 125 may include one or more computers that provide for the electronic transfer of funds between users or users' accounts pursuant to the terms of pending swaps. Electronically transferring funds may be accomplished using any suitable approach such as, for example, financial EDI (FEDI), electronic funds transfer (EFT), the Secured Electronic Transaction protocol (SET), the Joint Electronic Payments Initiative (JEPI), or any other suitable approach. In practice, the protocol stack used by the trading system may include secure protocols suitable to the chosen system implementation, such as, for example, secure HTTP (HTTPS), secure sockets layer (SSL), or any other suitable protocol or combination protocols.

Documents system 130 may include one or more computers and other devices (e.g., printers, scanners, faxes, etc.) suitable for maintaining swap-related documents and providing for the exchange of such documents. As used herein, swap-related documents may include, for example, term sheets, confirmations, International Swap Dealers Association (ISDA), documents, British Bankers Association (BBA) documents, or any other suitable type of document. Electronic versions of these documents may be maintained by documents system 130 as suitable files (e.g., PDF files). If desired, documents system 130 may provide users with opportunities to scan in term sheets for swaps previously obtained without the use of the trading system, or for proposed swaps. Documents system 130 may convert the documents to text using optical character recognition (OCR) software. Documents system 130 may scan the text and detect payment data for pending swaps. This information may be provided to application server 120. At the appropriate time (e.g., when payments are due), database server 120 may direct electronic commerce system 125 to transfer funds pursuant to the terms of the swap.

Documents system 130 may also examine term sheets for proposed swap terms and provide the terms to database server 120. Application server 120 or Internet server 115, may initiate an auction for the proposed swap. This may allow users to define proposed swaps by filling in paper term sheets. Users may, for example, fax or otherwise provide the paper term sheets to documents system 130 for processing.

Paging/dialing system 103 may be any suitable computer based system for dialing or paging users. Paging/dialing system 103 may dial or page a user to, for example, notify the user of a pending auction, notify the user that the user's completed proxy bid has been beaten by another bid, to connect users to orally confirm a swap, or for any other suitable purpose. Paging/dialing system 103 may for example, have suitable modems and software for paging users using, for example, the Simple Network Paging Protocol (SNPP). Paging/dialing system 103 may provide for automatic dialing of parties and for voice-to-voice communications over the Internet or a telephone dialing link, providing access devices 200 have suitable hardware and processing capacities (e.g., sound boards, microphones, speakers, etc.).

FIG. 1b shows an illustrative non-on-line arrangement for the trading system of the present invention. In the non-on-line arrangement of FIG. 1b, personal computers 180 are interconnected via network 175 to application server 121. Network 175 may be any suitable local area network (LAN), wide area network (WAN), or other suitable network. Personal computers and their interconnection via networks are well known. If desired, one or more personal computers 180 may be accessed by remote access device 183 to provide users with remote access to the system. Remote access device 183 may be any suitable device, such as a personal computer, personal digital assistant, cellular phone, or other device with remote access capabilities.

Application server 121 may run any suitable database engine, such as, for example, Microsoft SQL Server V.7.0. Application server 121 may maintain system information database 123. Client applications running on personal computers 180 may allow users to access the features of the system. The clients may, for example, pass SQL requests as messages to server 121. In another suitable approach, the client applications may invoke remote procedures that reside on server 121 using one or more remote procedure calls. Server 121 may execute SQL statements for such invoked remote procedures. In still another suitable approach, client objects executed by the client applications may communicate with server objects executed by server 121 using, for example, an object request broker (ORB). This may involve using, for example, Microsoft's Distributed Component Object Model (DCOM) approach. Any other suitable non-on-line based communications scheme may be used.

Electronic commerce system 125, documents system 130, paging/dialing system 103, or any suitable combinations thereof may be connected to application server 121 via links 107. Links 107 may be any suitable link, such as computer network links, Internet links, telephone links, wireless links, or any other suitable link. The functions of application server 121 and one or more of electronic commerce system 125 and documents system 130 may be combined into a single system if desired.

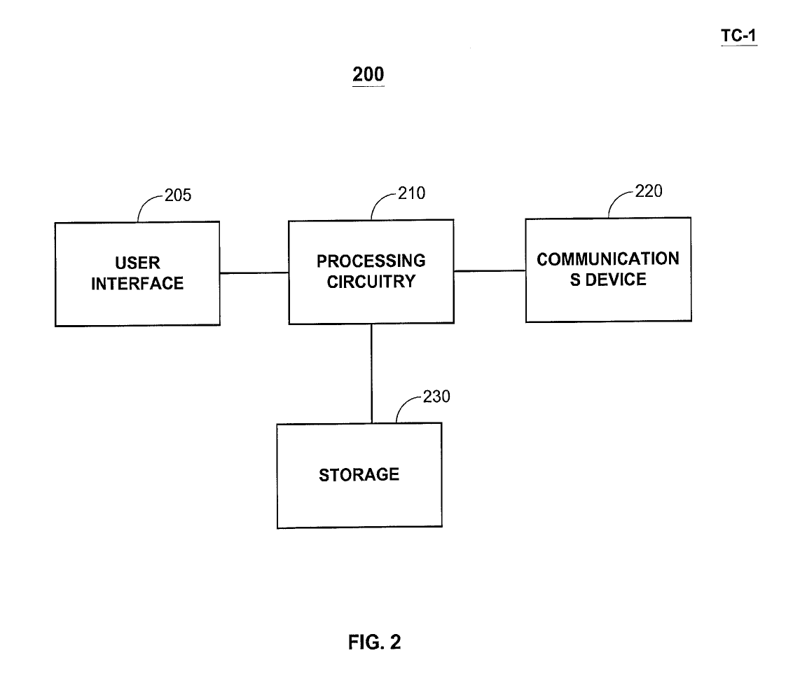

FIG. 2 shows an illustrative, generalized arrangement for the access devices 200 of FIG. 1a. Access devices 200 may have, for example, user interface 205, processing circuitry 210, communications device 220, and storage 230. User interface 205 may be any suitable input device, output device, or combination thereof. User interface 205 may include, for example, a pointing device, keyboard, touch-pad, touch screen, pen stylus, voice recognition system, mouse, trackball, cathode ray tube (CRT) monitor, liquid crystal display (LCD), voice synthesis processor and speaker, or any other suitable user input or output device. Processing circuitry 210 may include any suitable processor, such an Intel Pentium® microprocessor, and other suitable circuitry (e.g., input/output (I/O) circuitry, direct memory access (DMA) circuitry, etc.). Communications device 220 may be any device suitable for supporting communications over links 195. Communications device 220 may include, for example, a modem (e.g., any suitable analog or digital standard, cable, or cellular modem), network interface card (e.g., an Ethernet card, token ring card, etc.), wireless transceiver (e.g., an infrared, radio, or other suitable analog or digital transceiver), or other suitable communications device. Storage 230 may be any suitable memory, storage device, or combination thereof, such as RAM, ROM, flash memory, a hard disk drive, etc.

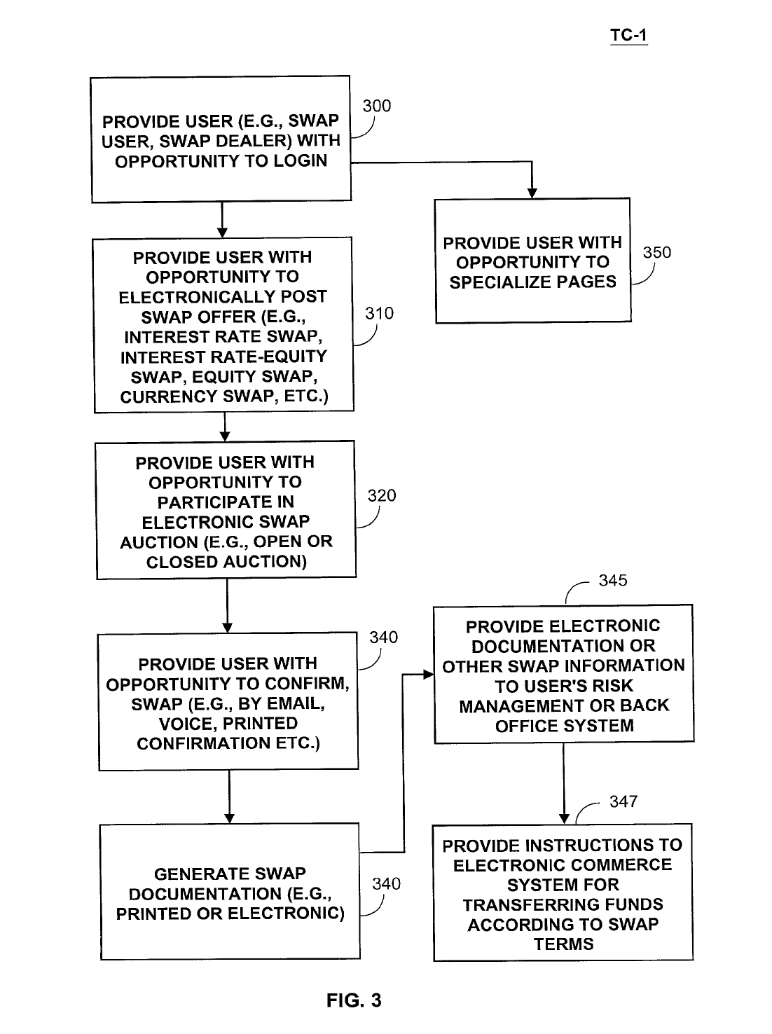

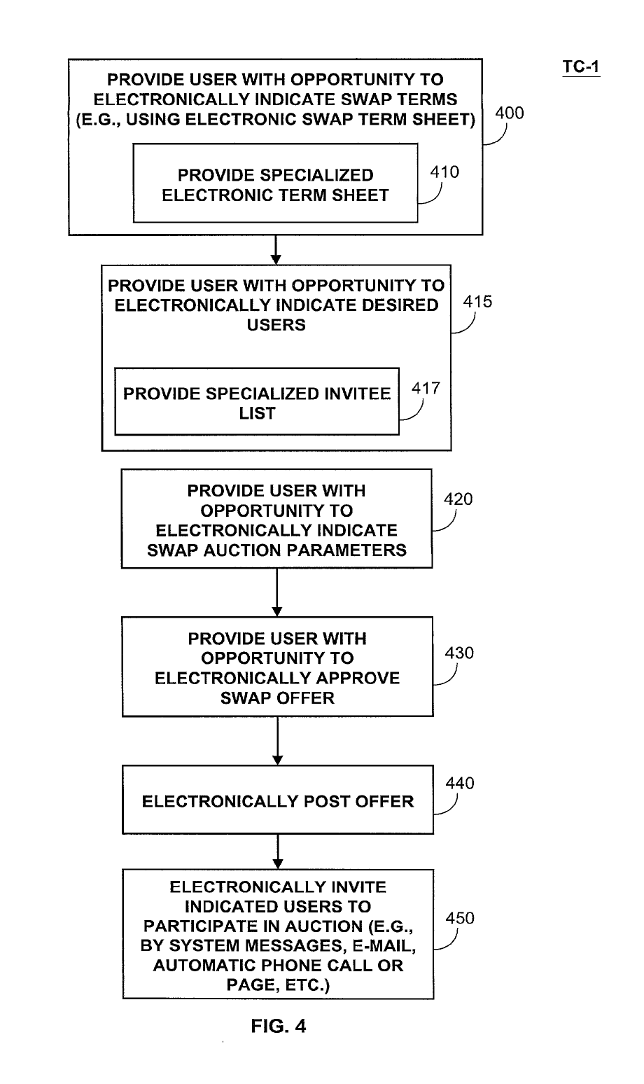

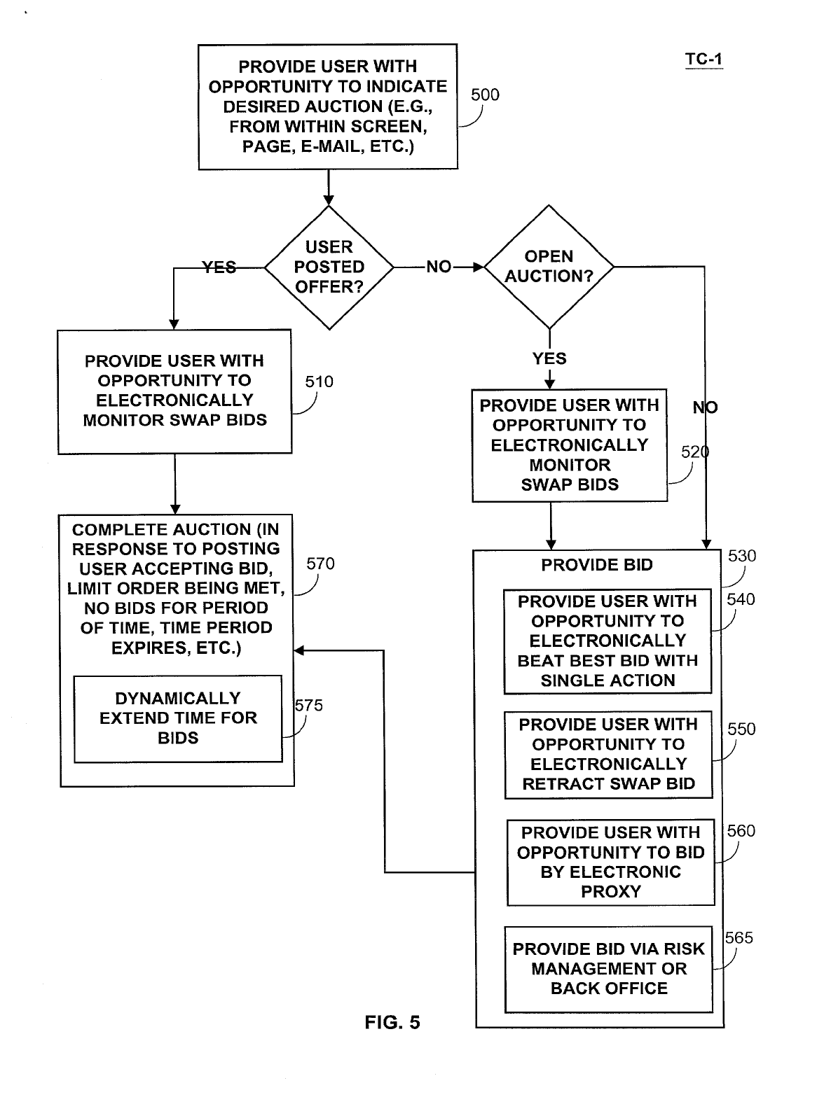

FIG. 3 is a flowchart of an overview of illustrative steps involved in providing users with access to various features of some embodiments of the present invention. FIGS. 4 and 5 show illustrative, more specific flowcharts of steps involved in providing features of various embodiments. The steps shown in FIGS. 3-5 may be performed in any suitable order, based on, for example, the features provided by a system and its implementation. If desired, some of the steps may be deleted, and others added.

Some of the steps shown in FIGS. 3-5 involve providing users with opportunities to interact with an electronic trading system. Such steps may be performed by, for example, a client application that is programmed to generate or download screens suitable to provide such opportunities, by an Internet browser that downloads suitable pages to provide such opportunities, or using any other suitable approach. Other steps may involve additional processing, such as inviting users to participate in auctions, providing auctions, posting transactions, or other types of processing. In non-on-line arrangements, such processing may be performed by the client or the server, depending on the chosen system implementation and the degree to which the processing involves querying system information database 123 (FIG. 1b). In on-line arrangements, such processing may be performed by access device 200, Internet and application server 115, or database server 120 (FIG. 1a), depending on, for example, the processing and storage capabilities of access devices 200, the chosen implementation for the markup language documents used, the degree to which the processing involves querying system information database 123, or other factors. For purposes of clarity and not of limitation, the following discussion will describe the steps shown in FIGS. 3-5 as being performed by “the system,” which is intended to include any non-on-line or on-line arrangement suitable for performing the steps shown.

At step 300, the system may provide users, such as swap users and swap dealers, or traders of other financial instruments, with opportunities to login to the system. This may be accomplished using any suitable approach. The system may, for example, provide a login page in response to a user accessing the system with a web-browser or other Internet navigational software. In another suitable approach, the system may provide a login screen in response to the user indicating a desire to launch an application (e.g., by selecting a program icon, by entering suitable path and file names, etc.). At step 310, the system may provide the user with an opportunity to post a swap offer. FIG. 4 shows illustrative steps involved in posting swap offers. Swap users, for example, may post swap offers to effect swaps with swap dealers. Swap dealers, for example, may post swap offers to effect inter-dealer swaps. Swap dealers may post swap offers to swap users if desired. The system may provide An electronic trading system user with an opportunity to indicate terms for a swap offer at step 400 of FIG. 4. The system may use any suitable user interface element or combination of elements to provide An electronic trading system user with an opportunity to indicate the terms of a swap. The system may use, for example, text boxes, drop-down lists, searchable text lists, check boxes, push buttons, radio buttons, any other suitable interface element or any suitable combination thereof. In another approach, system users may indicate terms for a swap offer by filling out a printed swap offer term sheet and faxing or otherwise providing the sheet to documents system 130 (FIGS. 1a and 1b) for processing.

Swap terms may include, for example, the user's position (e.g., whether the user will pay or received fixed rate payments), the swap settlement date, maturity date, stub period, whether the swap is callable, the call type, the notional quantity, whether the notional quantity is amortized or accreted, the payment frequency, fixed rate variables (e.g., how day counts are calculated, whether there are payment holidays and how to handle them, etc.), indexes for variable payment rates, equity indexes for interest rate-equity and equity swaps, floating rate variables (e.g., how day counts are calculated, whether there are payment holidays and how to handle them, etc.), what types of documentation are required (e.g., International Swap Dealers Association (ISDA) documents, British Bankers Association (BBA), documents, etc.), currency types (for currency swaps), strikes and fees or premiums (for caps and floors), or any other suitable swap term or combination of swap terms.

The system may provide users with one or more electronic swap term sheets to provide the opportunity of step 400. If desired, the system may provide one or more specialized electronic term sheets (step 410). Specialized electronic term sheets may include only those swap terms that are generally desirable to the user. For example, if a user is generally involved in equity swaps, then the user may desire to have an opportunity to select from one or more equity indexes when defining a swap. This user may also not find it particularly useful to have an opportunity to indicate an interest rate index. A specialized electronic swap term sheet for this user may include user interface elements that provide the user with opportunities to select equity indexes, and may not include any interface elements for indicating interest rates. As another example, a user who participates in interest rate swaps may generally confine the user's swaps to a particular type of interest rate (e.g., LIBOR). A specialized term sheet for this user may include interface elements that provide the user with opportunities to select one or more LIBOR rates, and may not include any interface elements that provide for indicating, for example, U.S. Treasury rates. Electronic term sheets may be specialized to include any suitable combination of swap terms for a given user. The system may provide specialized term sheets based on, for example, the user's login ID.

At step 415, the system may provide the user who is posting an offer (sometimes referred to as the “posting user”) with an opportunity to electronically indicate one or more users whom the posting user wishes to have bid on a swap offer (sometimes referred to herein as “invitee users”). A posting user may indicate one or more invitee users based on their credit-worthiness or other considerations. If desired, the system may provide the user with an opportunity to select one or more invitee users from a subset of all of the system users. The system may, for example, allow the posting user to indicate only swap dealers. If desired, the system may specialize a list of dealers to provide only those dealers that the posting user desires to have provided. The system may provide specialized invitee lists based on, for example, the user's login ID (step 417).

At step 420, the system may provide the posting user with an opportunity to indicate one or more swap auction parameters. Swap auction parameters may include, for example, whether a swap is open or closed, its start time, reserve rates or minimum bids, methods of confirmation (e.g., automatic, by electronic messages such as system messages or e-mail, by telephone, etc.), how the auction may terminate (e.g., end times, user acceptance, time period without bids, etc.), or any other suitable auction parameter. The system may also provide the posting user with an opportunity to indicate that a swap offer is a limit order—that the first bidder to bid the reserve rate or minimum bid is the winner of the swap auction.

At step 430, the system may provide the posting user with an opportunity to approve the swap offer. This may be accomplished using any suitable approach, the system may, for example, provide one or more pages or screens in which the swap offer terms, the indicated invitee users, the auction parameters, or any suitable combination thereof, are displayed for the posting user's review. A suitable interface element, such as a push button, may also be provided so that the posting user may indicate whether the offer is approved. After a swap offer has been defined and approved (if desired), the system may post the swap offer to system information database 123 of FIGS. 1a and 1b (step 440). The system may also invite the invitee users indicated at step 415 to participate in an auction for the swap offer.

The system may invite invitee users using any suitable approach. The system may, for example, determine if an invitee user is logged into the system and provide an alert-style system message alerting the user to the invitation. In another suitable approach, the system may post An electronic trading system message that an invitee user may access after logging into the system. In another suitable approach, the system may generate an e-mail alerting an invitee user to the swap offer. In another suitable approach, the system may provide instant pop-up message when the user is not logged in. In still another suitable approach, the application server may direct paging/dialing system 103 to automatically call or page an indicated user to alert the user of the offer.

The system may provide the posting user and the invitee users with opportunities to participate in swap auctions (e.g., step 320 of FIG. 3). FIG. 5 is a flowchart of illustrative steps involved in providing users with opportunities to participate in swap auctions. At step 500, the system may provide a user with an opportunity to indicate a particular swap auction that the user wishes to participate in. The user may indicate a particular swap auction by, for example, selecting the auction from an on-screen list of pending auctions. In another suitable approach, The user may indicate a particular swap auction by, for example, selecting an Internet link from an e-mail notification for the auction that brings the user to an auction page. Any other suitable approach may be used.

After the user has indicated an auction that the user desires to participate in, the system may determine whether the user was the posting user or an invitee user. When the user is the posting user, the system may provide the user with an opportunity to electronically monitor bids for the swap (step 510). The system may provide a display screen or page that is updated in real time to show current bids (e.g., using a real-time non-on-line data streaming approach, XML polling, or any other suitable approach). The system may also provide a posting user with an opportunity to accept a bid that is not the best bid. Providing posting users with this opportunity may be desirable when, for example, users may want the ability to accept a bid that is not the best bid but is made by a better credit risk. This feature may be more appropriate in, for example, closed auctions where bidders cannot see the bids of other users. While bid acceptance may be used in open auctions, allowing posting users to usurp the “best bid wins” methodology by accepting a bid that is not the best bid may be unacceptable to some bidders, and may tend to cause them to dislike participating in auctions for fear of wasting their time.

When the user who indicated a desired auction at step 500 is an invitee user, the system may determine whether the auction is an open or closed auction. When the auction is an open auction, the system may provide the user with an opportunity to monitor pending bids for the desired auction (step 520). In either case, the system may provide the user with an opportunity to electronically bid on the swap (step 530). Providing a user with an opportunity to electronically bid on a swap may be accomplished using any suitable approach. The system may, for example, provide the user with an opportunity to enter an interest rate, index, amount of currency, or any other bid suitable for the type of swap offered. The system may also provide the user with an opportunity to beat the best pending bid with a single action (e.g., the pressing of a single button, clicking of a single link, etc.) at step 540. The user may also beat the best pending bid by entering a bid using some other suitable approach.

The system may provide the user with an opportunity to retract the user's pending bid. Retraction of bids may be limited in any suitable way. For example, users may only be able to retract bids while the auction is still pending or before a bid is accepted. Alternatively, users may have an absolute time period during which they may retract a bid even if the auction is complete. In approaches where a confirmation of a swap is required, retraction of bids may be performed, for example, at any time up until the swap is confirmed. If the auction is complete when the bid is retracted, the posting user may re-post the bid manually or the system may re-post the bid automatically in response to the retraction.

The system may provide a user with an opportunity to bid by electronic proxy at step 560. When bidding by proxy, a user may set a proxy rate (or other terms depending on the financial instrument traded) which the system then uses to automatically bid on the user's behalf. A user may desire to bid by electronic proxy when, for example, an auction is to be completed in a small amount of time, when the user cannot monitor an auction, or for any other reason. The user may indicate a desire to bid by proxy and indicate the user's best bid. Each time the system receives a bid for a swap, the system may automatically bid for the user a predetermined amount better than the best bid (e.g., one-tenth of one basis point (0.001%). The system may keep bidding by proxy for a user until the user's best bid is reached. If a better bid is posted by another user, the system may notify the proxy bidder (e.g., by e-mail or system message) that the proxy bidder's best bid has been beaten. The proxy bidder may rejoin the auction before it is completed and enter another bid if desired.

The system may complete an auction at step 570. The system may complete an auction in response to any suitable event. The system may, for example, complete an auction in response to a posting user accepting a bid. The system may also complete an auction at a particular time set by the posting user, when no new bids have been received after a predetermined period of time, when a limit order is met, or in response to any other suitable event. If desired, the system may dynamically extend the time for bids past a scheduled time when, for example, a certain number of bids are received within a predetermined time of the scheduled end time of the auction (step 575).

Returning to FIG. 3, the system may provide users with opportunities to confirm swaps when, for example, the completion of an auction itself is not sufficient to create a binding swap (step 330). The system may provide users with this opportunity using any suitable approach. The system may, for example, provide swapping users with opportunities to electronically sign e-mails that are exchanged between the swapping users. In another suitable approach, the system may provide the users with an opportunity to immediately confirm the swap orally using computer based telephony (e.g., Internet Protocol (IP) telephony). The system may, for example, generate printed confirmations that are signed and exchanged by the parties. In still another suitable approach, the system may allow users to confirm the swaps using instant pop-up messages that prompt the users to confirm the swap. Any other suitable approach may be used.

At step 340, the system may generate swap documentation. Swap documentation may include any suitable printed or electronic documents, such as printed or electronic ISDA, BBA, or other documents. The system may also generate electronic swap documentation or swap information that is provided to the user's risk management or back office system (step 345). This may provide for straight-through processing of the swap without requiring the user to manually enter the terms of the swap into the user's risk management or back office system. The system may also provide instructions to electronic commerce system 125 to transfer funds according to swap terms at step 347.

The system may provide users with opportunities to specialize their electronic swap term sheets, invitee lists, or any other display screens or pages (step 350). This may be accomplished using any suitable approach. The system may, for example, provide a display screen or web page in which the user is provided with an opportunity to indicate desired swap terms, invitee types, or other specialization information. Alternately, the system provider may interview the user to determine the user's desired swap parameters, invitee, types, or other information, and provide specialized screens or pages.

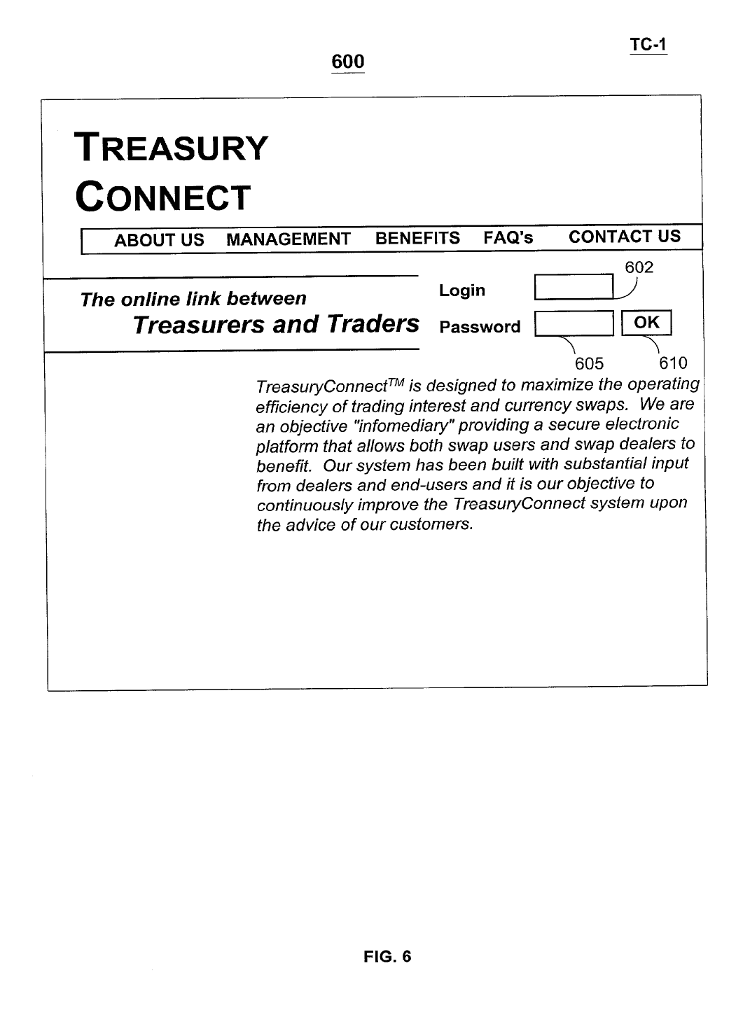

The features of an electronic trading system in accordance with the present invention may be presented to users using any user interface suitable to the chosen non-on-line or on-line approach used to implement the system. FIGS. 6-19 show one illustrative graphical user interface for an electronic swap trading system in accordance with one embodiment of the present invention. For purposes of clarity and not limitation, FIGS. 6-19 will be described as illustrative web pages for use in an on-line electronic swap trading system. The interface shown may, in practice, be used as suitable display screens in a non-on-line based system if desired.

The illustrative web pages shown in FIGS. 6-19 illustrate various features of some embodiments of the present invention as they may be used to provide users with opportunities to post offers and bid on swaps. The types of swaps shown in the following figures are only illustrative examples. Various features of the present invention may be used to provide users with opportunities to post offers and bid on any other suitable type of swap. Moreover, the user interface elements shown in the figures are only illustrative, and may be replaced with any other user interface elements suitable for the features with which the illustrative interface elements are associated (e.g., drop-down menus, text fields, buttons, radio buttons, tabs, links, check boxes selectable graphics, or any other switchable interface element).

For purposes of clarity and not of limitation, the following discussion will describe the web pages of FIGS. 6-19 as being provided by “the system,” which is intended to include any non-on-line or on-line arrangement suitable for providing one or more of the web pages (e.g., the systems of FIGS. 1a and 1b).

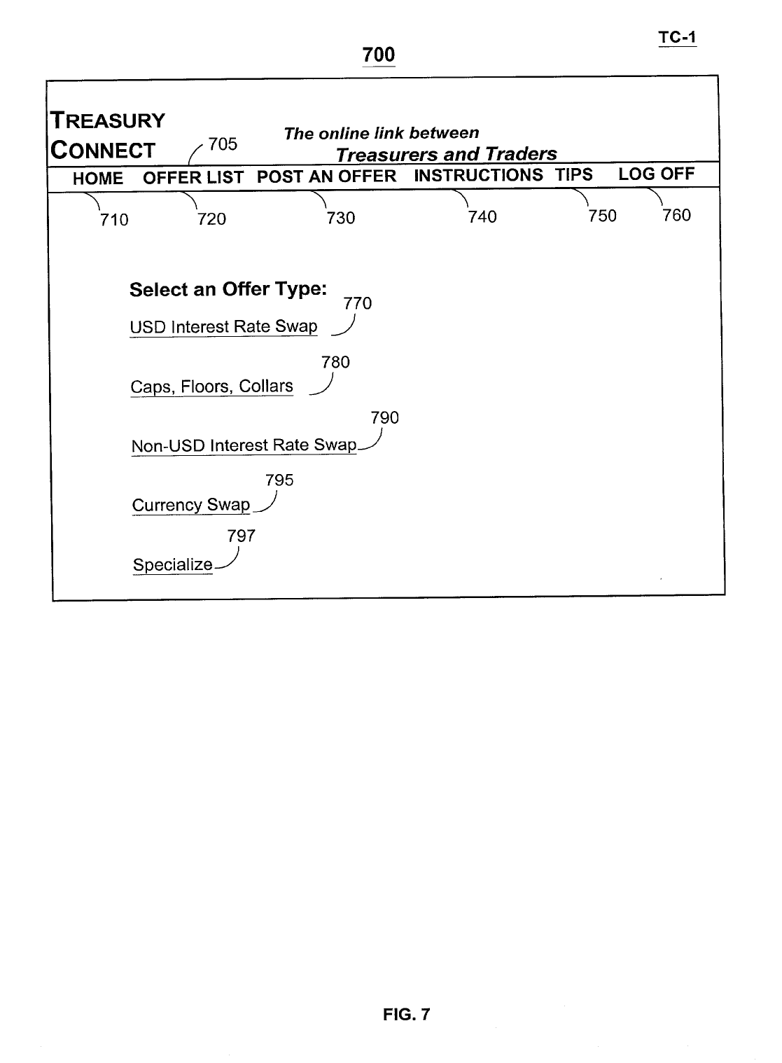

An illustrative login page 600 in accordance with one embodiment of the present invention is shown in FIG. 6. Login page 600 may include text boxes 602 and 605 for providing a user with an opportunity to enter the user's login ID and password. The user may indicate that the user has finished entering his or her user ID and password by, for example, pushing button 610. In response, the system may provide an offer selection page. An illustrative offer selection page 700 is shown in FIG. 7.

Offer selection page 700, and other pages of the system may include graphics and advertisements that have not been shown to avoid overcomplicating the figures. Graphics may include, for example, product or service provider brands that indicate to the user the provider of the service. Advertisements may be any suitable text, graphic, video or other visual advertisement. Visual advertisements may have associated audio. Pure audio advertisements may be played without displaying visual indicators of their availability if desired.

Offer selection page 700, and other pages within the system, may include menu bar 705. Menu bar 705 may provide users with opportunities to access various features of the system. Users may select items on menu bar 705 to indicate a desire to, for example, go home (i.e., re-login to the system) by selecting menu item 710, view an offer list by selecting menu item 720, post an offer by selecting menu item 730, get instructions on how to use the system by selecting menu item 740, obtain swap investment tips by selecting menu item 750, logoff by selecting menu item 760, or perform any other suitable function.

Offer selection page 700 may also include one or more links that provide the user with an opportunity to indicate swap types for which the user wishes to post an offer. In this example, the user may indicate a desire to: post an offer for a United States Dollar (USD) interest rate swap by selecting link 770, post an offer for a cap, floor or collar by selecting link 780, post an offer for a non-USD interest rate swap by selecting link 790, and post an offer for a currency swap by selecting link 795. These offer types are only illustrative as the user may be provided with opportunities to select any other suitable offer type (e.g., equity swaps, basis swaps, etc.). Page 700 may also include link 797 for providing users with opportunities to specialize their web pages.

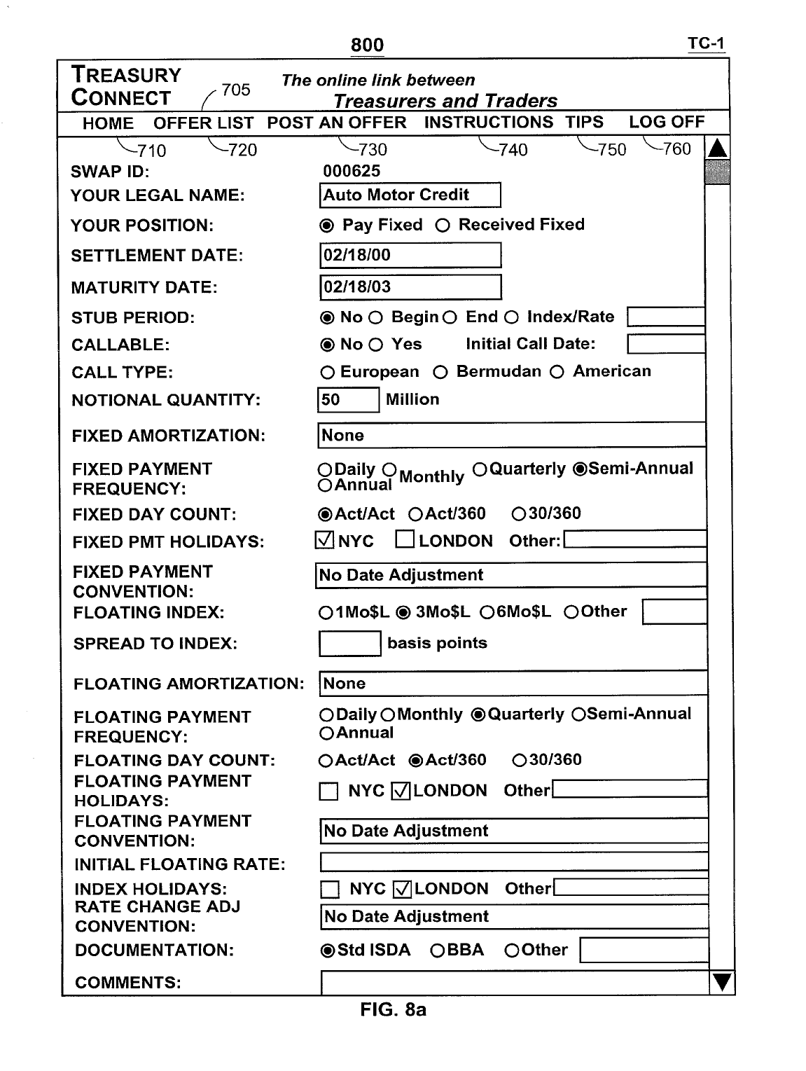

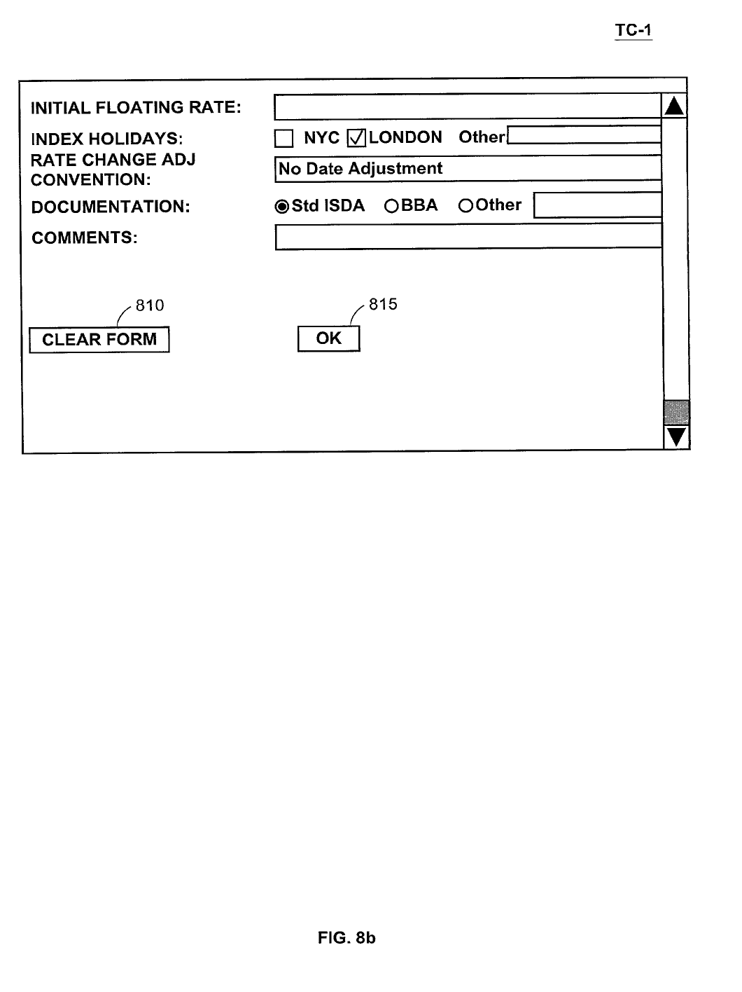

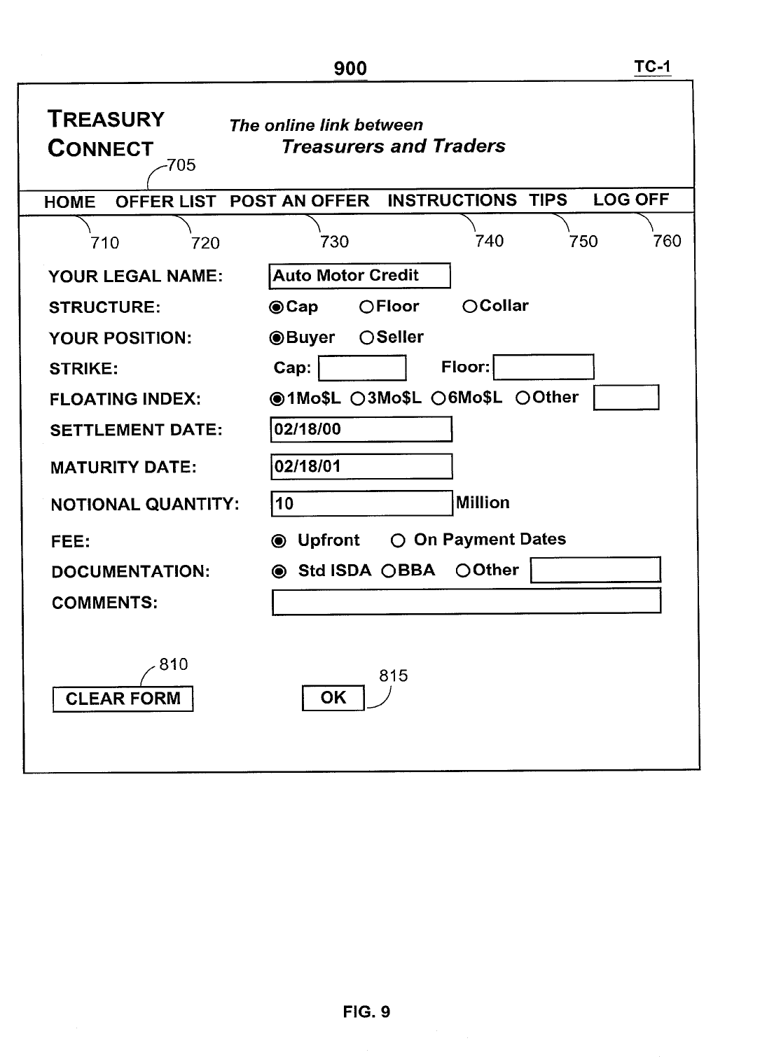

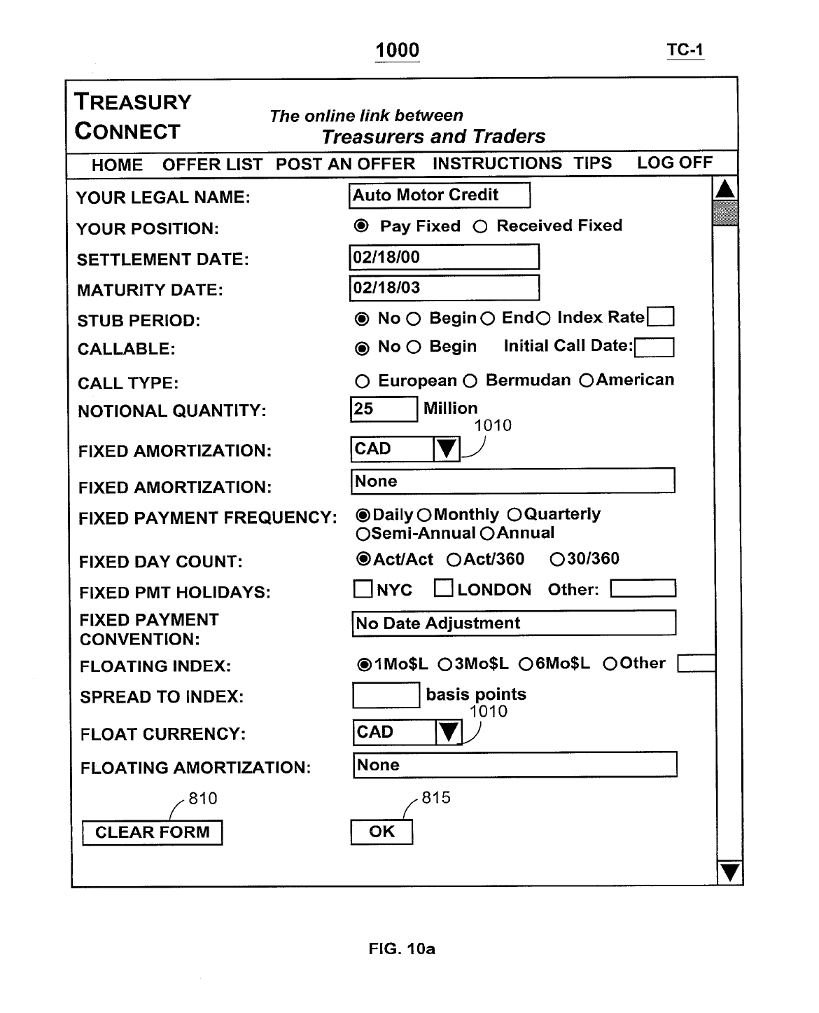

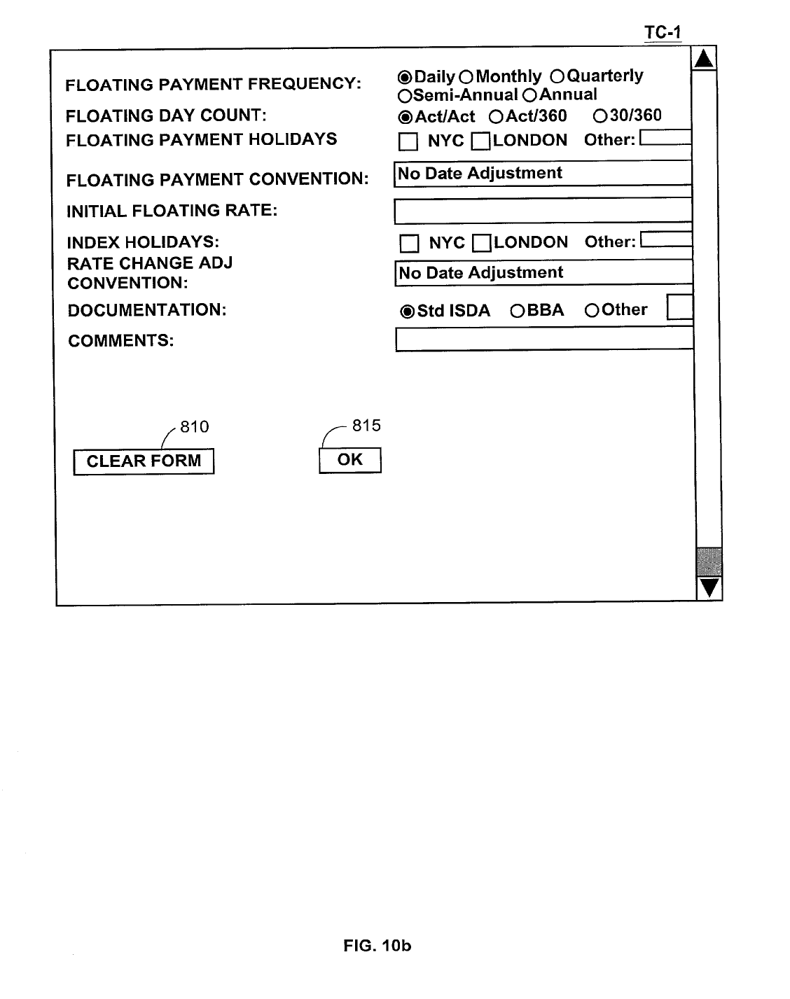

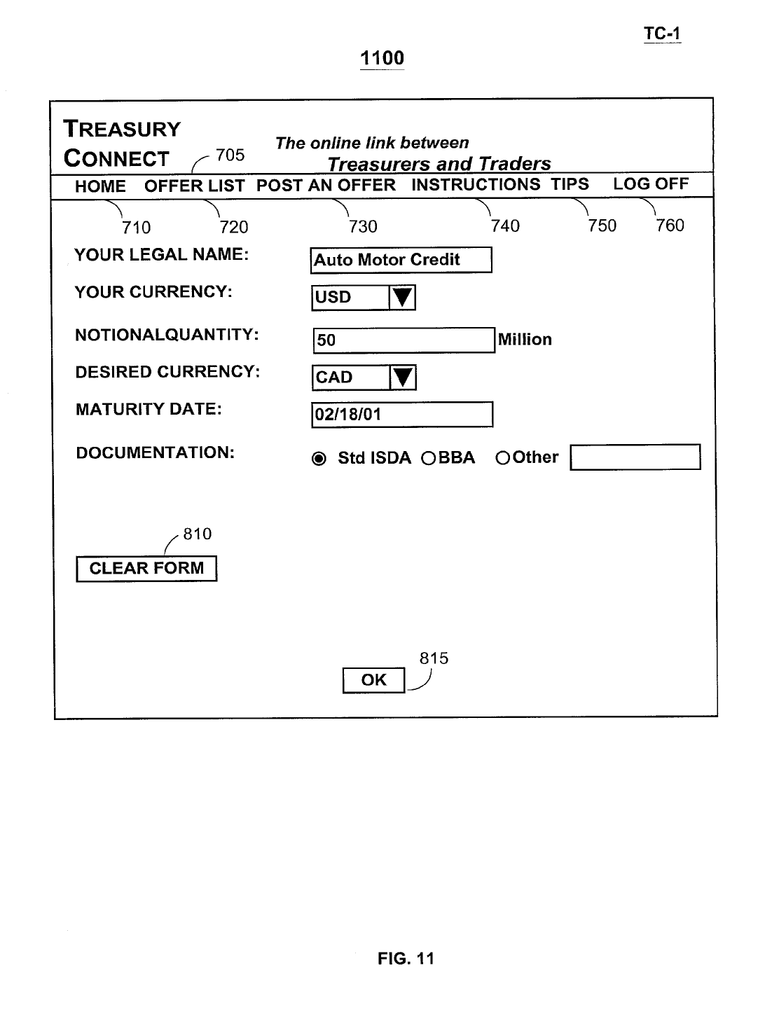

In response to a user indicating a desire to post an offer (e.g., by selecting a link for an offer type), the system may provide an electronic term sheet. FIGS. 8a and 8b show an illustrative electronic term sheet page 800 for USD interest rate swaps. FIG. 9 shows an illustrative term sheet page 900 for caps, floors, and collars. FIG. 10 shows an illustrative term sheet page 1000 for non-USD interest rate swaps. FIG. 11 shows an illustrative term sheet page 1200 for currency swaps.

Term sheet page 800 of FIGS. 8a and 8b is an illustrative specialized term sheet for a USD interest rate swap. As shown, the system provides the user with opportunities to indicate various terms of a proposed swap. The user, in this example, Auto Motor Credit, may indicate the user's position—whether the user wishes to pay fixed rate payments or pay floating rate payments. In this example, Auto Motor Credit has chosen to pay fixed rate payments. The user may indicate the date on which the swap begins, commonly referred to as the swap settlement date. The user may indicate the date on which the swap expires, commonly referred to as its maturity date.

The user may also indicate whether there is a stub period at the beginning or the end of the swap. Stub periods are periods of time shorter than an interest rate period that may begin or end a swap. For example, assume that a user proposes a swap on March 15 with semi-annual payments due on June 1 and December 1. The initial period from March 15 until June 1 is a stub period—it is not a full interest rate period. The system may provide the user with an opportunity to indicate where the user desires a stub to be positioned (e.g., at the beginning or the end of the term of the swap), and whether a different index or rate should be applied. The user may also indicate whether a swap is callable—whether the user may request a counter party to make a payment on a date other than a scheduled payment date. If a proposed swap is callable, the user may indicate a call type.

The user may indicate the notional quantity, or principal value, of the swap. In this example, the notional value is $50 Million. The user may specify whether and how the notional amount is amortized for both the fixed rate side and the variable rate side of the swap. In this example, the user is not provided with an opportunity to accrete the notional amount. This may occur because the user does not desire to have such an option on the user's specialized page 800.

In this example, the user may also indicate the payment frequency, day count, payment holidays, and change conventions for the fixed rate and floating rate sides of the swap. The day count is used to calculate the amount due in a given period. For example, a periodic payment=day count*the periodic rate*the notional amount. In this example, page 800 has been specialized to include only three day count types. For debt instruments such as, for example, U.S. Treasury Bonds and Notes, the day count may be calculated by, for example, dividing the actual number of days elapsed by the number of days in a given semi-annual coupon period. The day count may also be calculated by, for example, dividing the actual number of days in a period (e.g., thirty-one) by 360 days. Periods may be set to a fixed length by, for example, setting the day count to 30 days divided by 360 days. Any other suitable approach may be used. Payment holidays may be selected to reflect holidays in various trading markets, such as holidays in the New York Stock Exchange or the London Exchange. Users may indicate a payment convention to define how interest rates are calculated for periods with holidays (e.g., add a day, leave alone, roll forward, roll back etc.). The system may also provide the user with an opportunity to indicate a spread to the floating rate index. The user may request, for example, that the floating rate be a number of basis points above or below the indicated floating index. The system may also provide the user with an opportunity to indicate an initial floating rate.

A further example of specialization of page 800 for this user is illustrated by the available options from which the user may select a floating index. Of all of the possible interest rate and equity indexes, the user in this example has had page 800 specialized to provide the user with an opportunity to select only LIBOR rates. The system also, however, provides the user in this example with an opportunity to enter an unlisted interest rate or equity index. This may provide the user with a specialized page that is optimized for the user's customary interest swaps, but that also allows the user to perform other interest rate or equity swaps from the same page if desired. Page 800 also provides the user with opportunities to specify whether any documentation must be generated when a trade is confirmed, and to enter any user comments.

FIG. 9 shows an illustrative specialized term sheet that the system may provide in response to a user indicating a desire to post an offer for a cap, floor, or collar (e.g., by selecting link 780 of FIG. 700). The user may, for example, specify the desired swap product (e.g., cap, floor, or collar), the user's position (e.g., buyer or seller), the strike, the settlement date, maturity date and the notional quantity for the product. The user may also specify when the fee or premium for the cap, floor, or collar is due.

An example of specialization of page 900 for this user is illustrated by available options from which the user may select a floating index (sometimes referred to as a reference rate), for the cap, floor, or collar. Of all of the possible interest rate and equity indexes, the user in this example, has had page 900 specialized to provide the user with an opportunity to select only LIBOR rates. The system also, however, provides the user in this example with an opportunity to enter an unlisted interest rate or equity index. This may provide the user with a specialized page that is optimized for the user's customary caps, floors, or collars, but that also allows the user to define offers for caps, floors, or collars based on other rates or indexes from the same page if desired.

FIGS. 10a and 10b show an illustrative specialized electronic term sheet page 1000 that the system may provide in response to a user indicating a desire to post an offer for a non-USD interest rate swap (e.g., by selecting link 790 of FIG. 7). FIG. 10b shows the bottom of page 1000 as it might look in response to a user scrolling or paging downward. Page 1000 of FIGS. 10a and 10b includes many of the same fields as the illustrative USD swap page 700 of FIG. 7. Page 1000 includes an additional element, in this example drop-down lists 1010, that provide the user with an opportunity to specify currencies in which the fixed rate and floating rate payments will be made.

FIG. 11 shows an illustrative electronic term sheet page 1200 that the system may provide in response to a user indicating a desire to post an offer for a currency swap. (e.g., by selecting link 795 of FIG. 7). the user may indicate, for example, the currency the user wishes to trade, a notional amount of that currency, the desired or target currency, and the maturity date of the trade (i.e., the date on which the trade occurs).

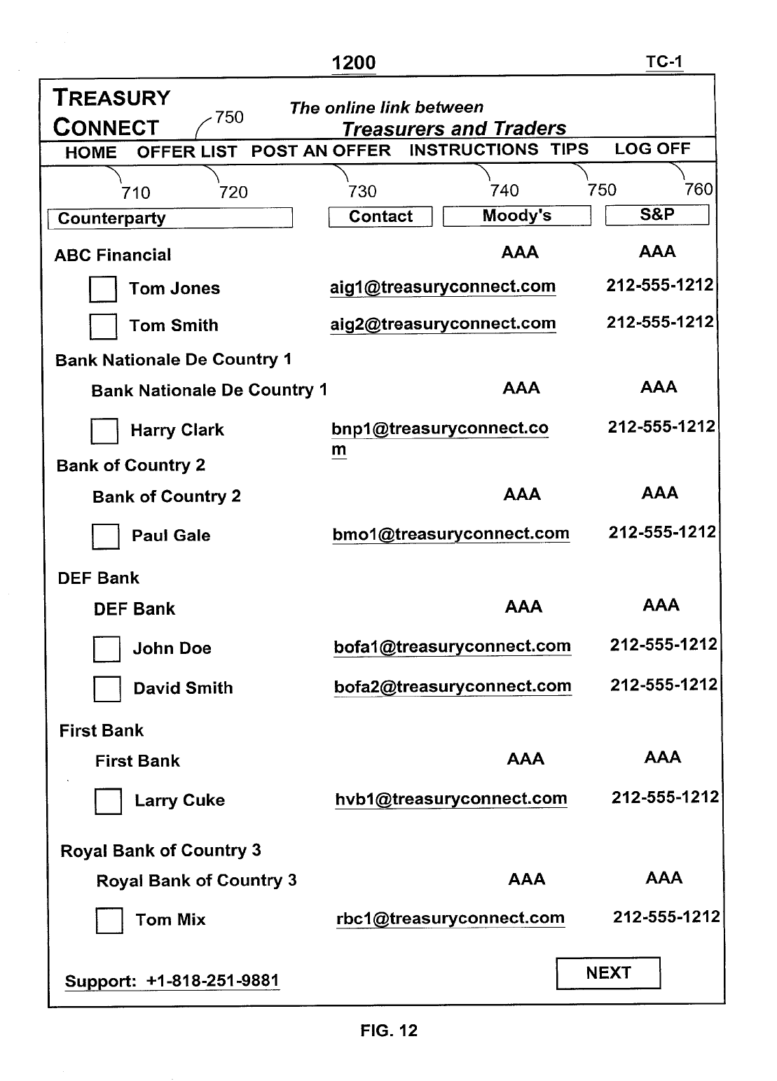

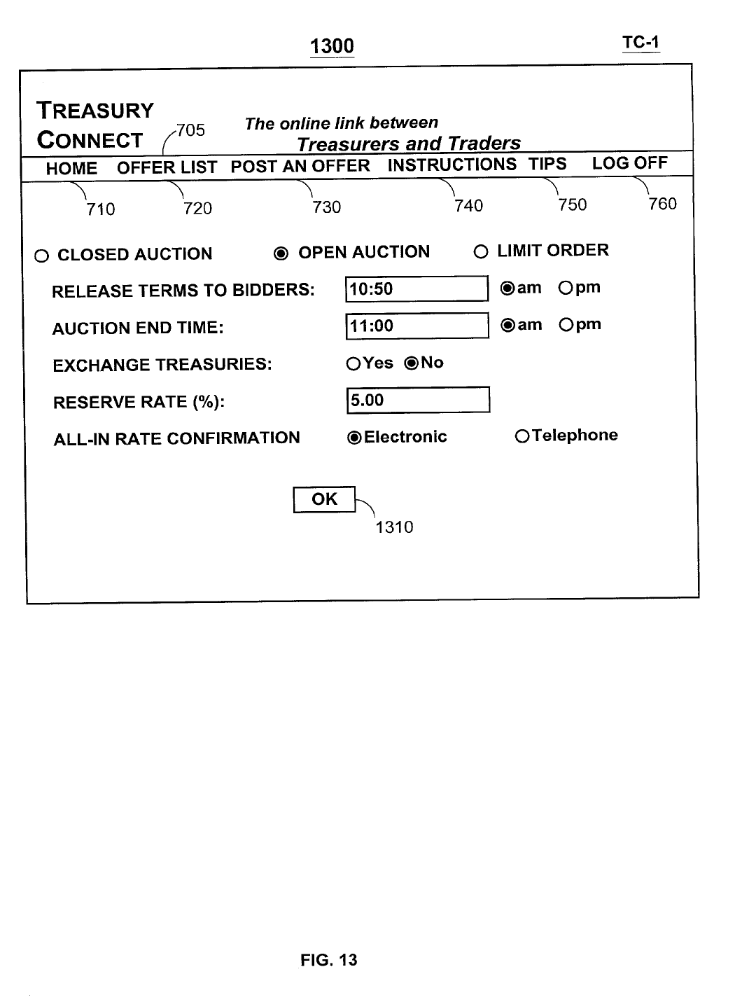

The user may indicate a desire to clear the user's indications in pages 800, 900, 1000, and 1200 by, for example, pushing button 810. In response, the system may provide a blank page for the user to fill in terms. The user may indicate that the user is finished defining an offer by, for example, pushing button 815 of pages 800, 900, 1000, and 1010. In response, the system may, for example, provide an invitee page. Invitee pages may provide a list of counter parties that a user may invite to participate in an auction for a swap offer. FIG. 12 shows an illustrative specialized invitee page 1200. Invitee page 1200 is specialized in that it only provides swap user Auto Motor Credit with opportunities to select the swap dealers (and not other swap users) that Auto Motor Credit may invite to participate in an auction for a swap offer. The user may indicate that the user is finished indicating invitees by, for example, pushing button 1210. In response the system may, for example, provide an auction parameters page. Auction parameter pages may provide the user with an opportunity to indicate whether, for example, an auction is to be closed or open, whether the auction may be satisfied by a limit order, a start time for the auction, an end time for an auction (if desired), a minimum bid (sometimes referred to as a reserve rate), how a swap is confirmed (e.g., automatically, electronically, by telephone, etc.), or any other suitable auction parameter. FIG. 13 shows an illustratve auction parameters page 1300.

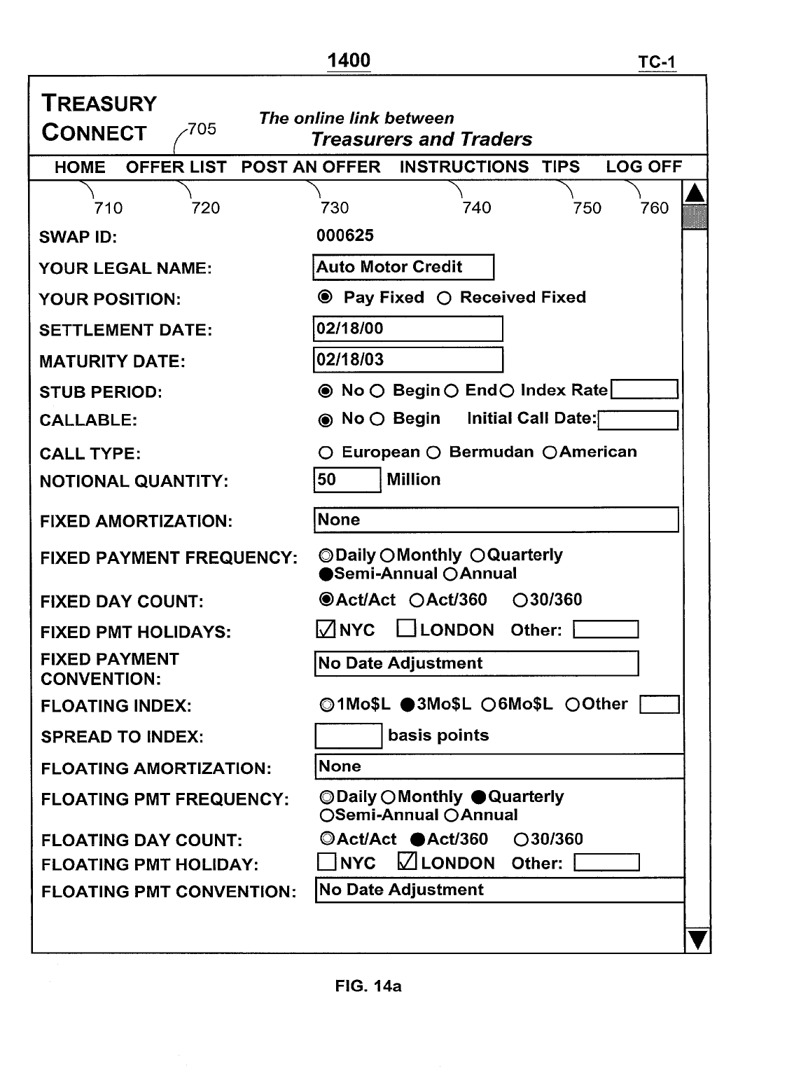

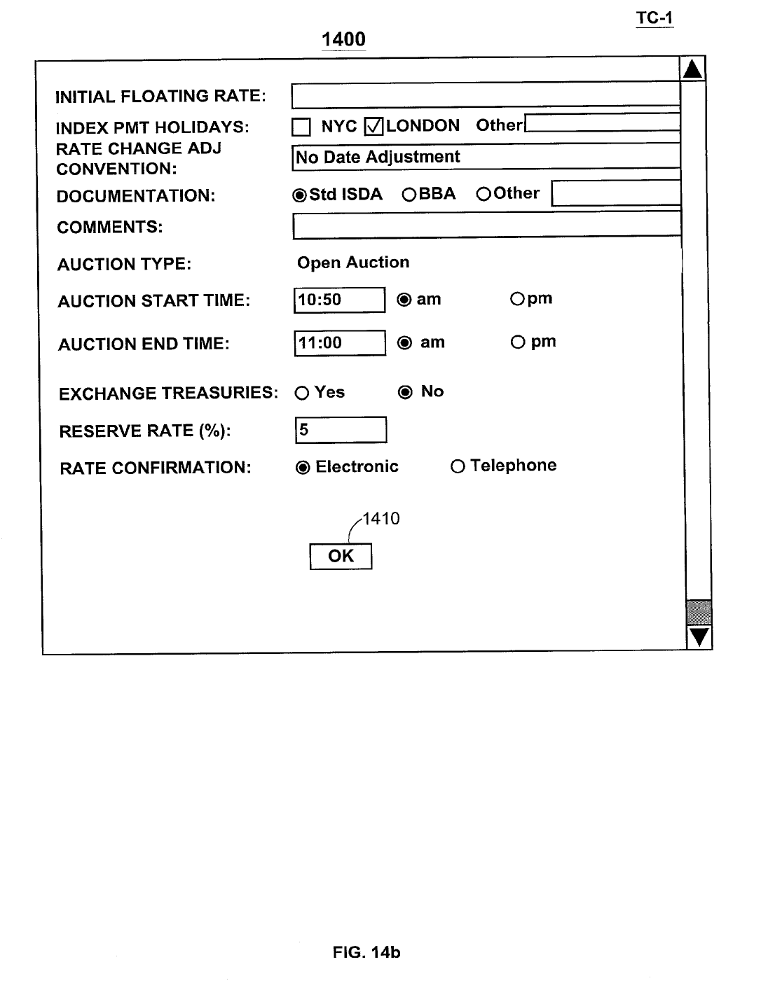

In response to a user indicating that the user has indicated all parameters for an auction (e.g., by pushing button 1310 of page 1300), the system may provide one or more confirmation pages. Confirmation pages may display the user's indicated swap terms, invitees, auction parameters, or any suitable combination thereof. FIGS. 14a and 14b show illustrative confirmation page 1400 that display the user's swap terms and auction parameters. FIG. 14a shows the top of page 1400. FIG. 14b shows the bottom of page 1400 as it might look in response to a user scrolling or paging downward. A user may confirm the offer by, for example, pushing button 1410. In response, the system may post the offer, invite the invitees, and provide the user with an opportunity to participate in an auction for the swap.

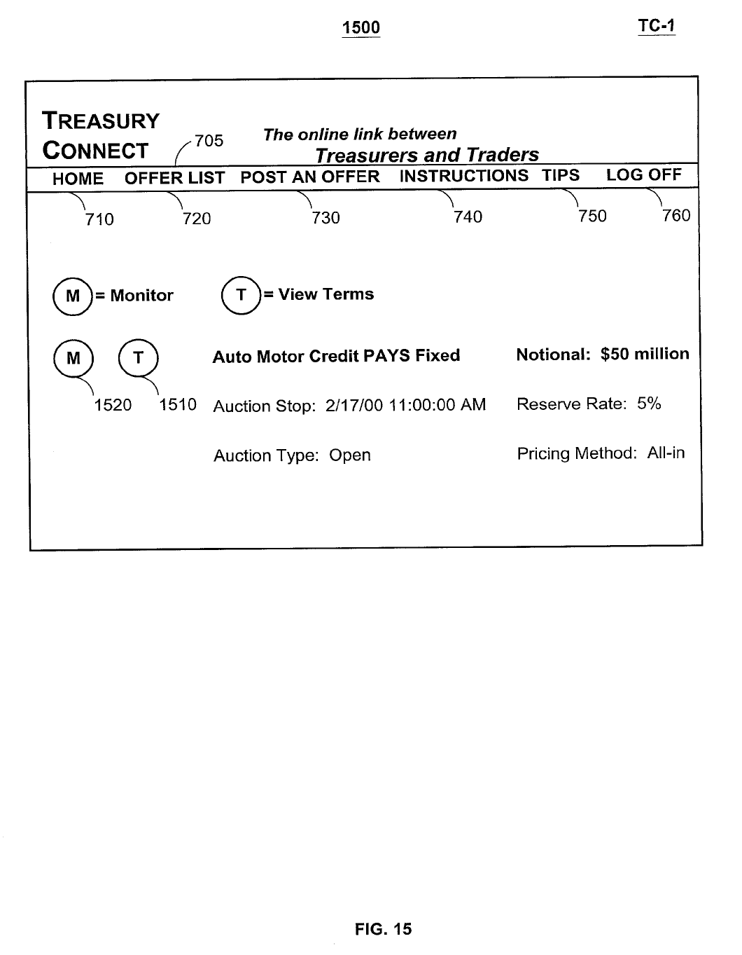

FIG. 15 shows an illustrative offer list page 1500 that the system may provide in response to, for example, a user selecting offer list menu item 720. Offer list page 1500 may provide a list of pending offers that the user has either posted or been invited to bid on. In this example, there is only a single offer. The user may indicate a desire to view the terms of a swap offer by, for example, pushing a button 1510 associated with the swap offer. In response, the system may provide an electronic term sheet page that lists the terms of the offer.

The user may indicate a desire to monitor an offer by, for example, pushing a button 1520 that is associated with the offer. In response, the system may provide an auction page for the user. When an offer has been posted as an open auction, an auction page for the offer may display the pending bids for an offer. When an offer has been posted as a closed auction, an auction page for the offer may only provide the user with an opportunity to place a bid.

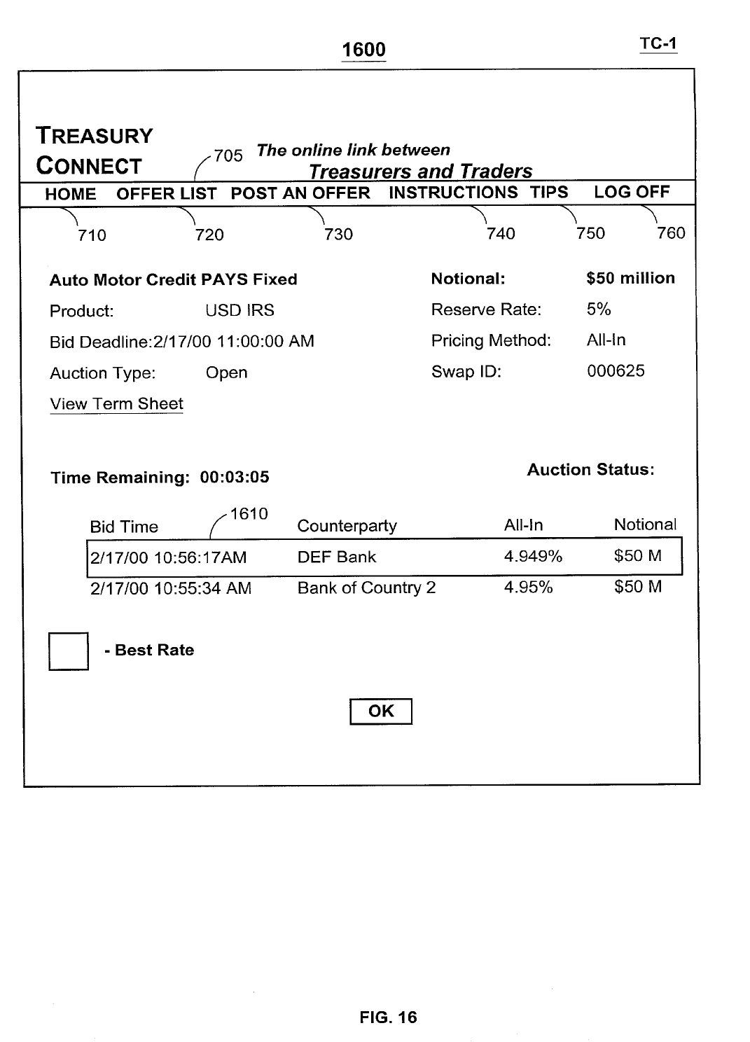

FIG. 16 shows an illustrative auction page 1600 for an open auction that may be provided to a posting user. The example of FIG. 16 shows an auction for an interest rate swap in which the best bid (in this example the lowest rate), wins the auction. Bidding users may bid progressively until the best-bid wins. As shown in FIG. 16, the posting user may view the bids of counter parties in real-time. Page 1600 may also include an indicator of the best bid, such as indicator 1610. Indicator 1610 may, for example, highlight the best bid, surround the best bid, or change the display characteristics of the best bid in any suitable fashion. If desired, the bid list may be dynamically re-orderable so that the best bid is always displayed at the top of the list.

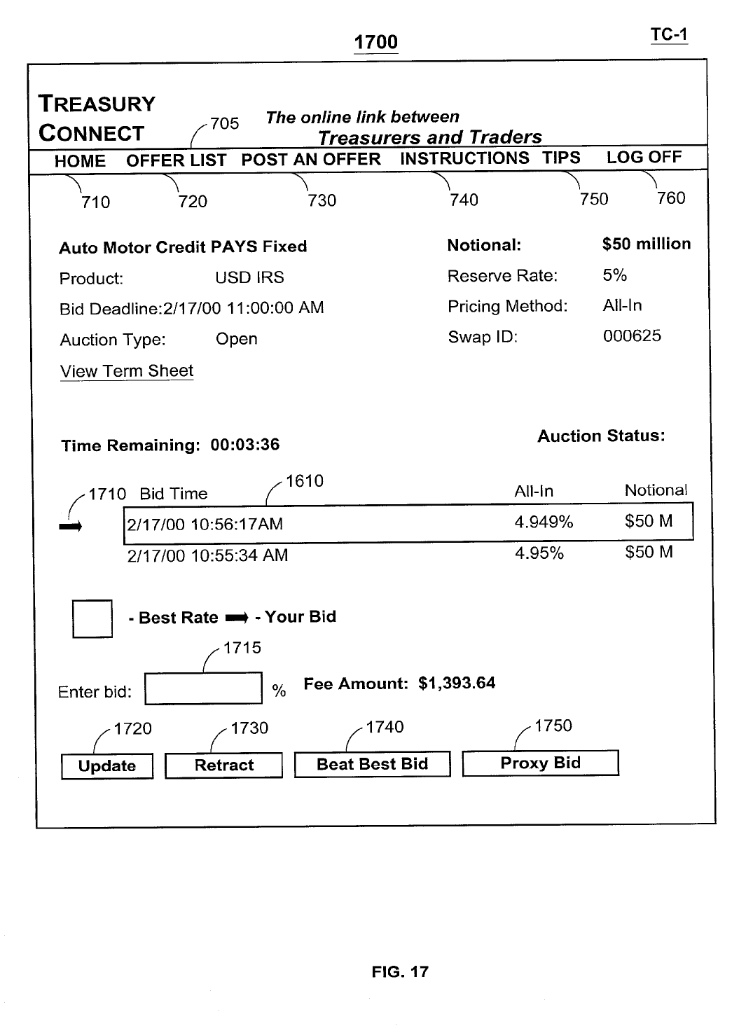

FIG. 17 shows an illustrative auction page 1700 for an open auction that may be provided to an invitee user. As shown in FIG. 17, the invitee may be provided with an opportunity to monitor pending bids while the identities of the bidders remain secret. Page 1700 may include an indicator of the invitee user's current bid, such as indicator 1710. Indicator 1710 may, for example, highlight the user's bid, surround the user's bid, or change the display characteristics of the user's bid in any suitable fashion. If desired, page 1700 may also include indicator 1610 to indicate the best bid.

Page 1700 may provide the user with opportunities to update the user's bid, retract the user's bid, beat the best bid, or bid by proxy. The user may indicate a desire to update the user's bid by, for example, entering a bid in text box 1715 and pushing button 1720. The user may indicate a desire to beat the best bid by a predetermined amount (e.g., 10 bps) by, for example, pushing button 1740. The user may indicate a desire to retract the user's bid by, for example, pushing button 1730. In response to each of these, the system may update both the posting user's page 1600 (in this example Auto Motor Credit's page 1600) and the invitee users' pages 1700 (in this example Bank of America and Bank of Montreal's pages 1700) to reflect the new bids or that a bid was retracted. The update may occur in real time, with a fixed period, or using any other suitable approach. The user may indicate a desire to bid by proxy by, for example, entering the user's best bid into text box 1715 and pressing button 1750. In response, the system may continue to enter bids for the user that are a predetermined amount higher than the best bid (e.g., 10 bps) until the user wins the auction, the user's best bid is reached, or the auction is completed for some other reason.

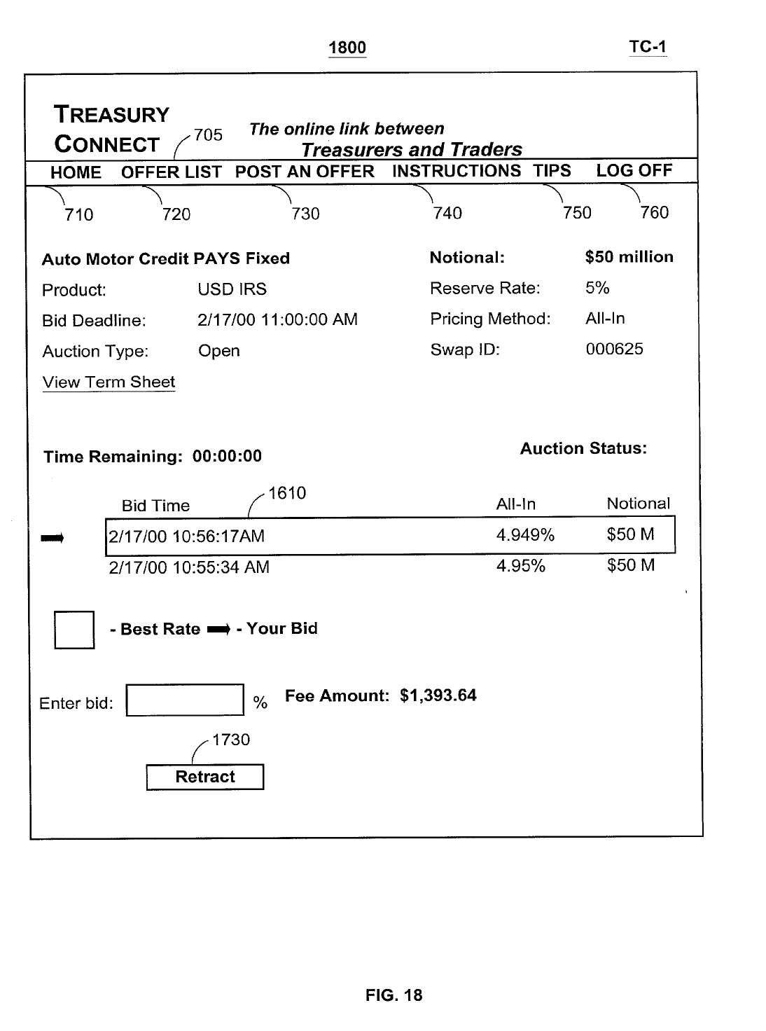

FIG. 18 shows an illustrative page 1800 that the system may provide to an invitee of an open auction when the auction is complete. In this example, the auction was completed when its time ran out. Page 1800 may indicate the bids pending when the auction was completed, and provide the user with an opportunity to retract the user's winning bid if desired. In response to a user indicating a desire to retract a winning bid (e.g., by pressing button 1730), the system may retract the bid and electronically notify the offering user of the retraction. The system may also provide the offering user with an opportunity to accept the next-best bid. In response to the offering user accepting the next-best bid, the system may electronically notify the bidding user of the acceptance. If desired, the system may provide the bidding user with an opportunity to retract his or her bid. This may continue until, for example, a bid is accepted and not retracted, or until there are no bids remaining.

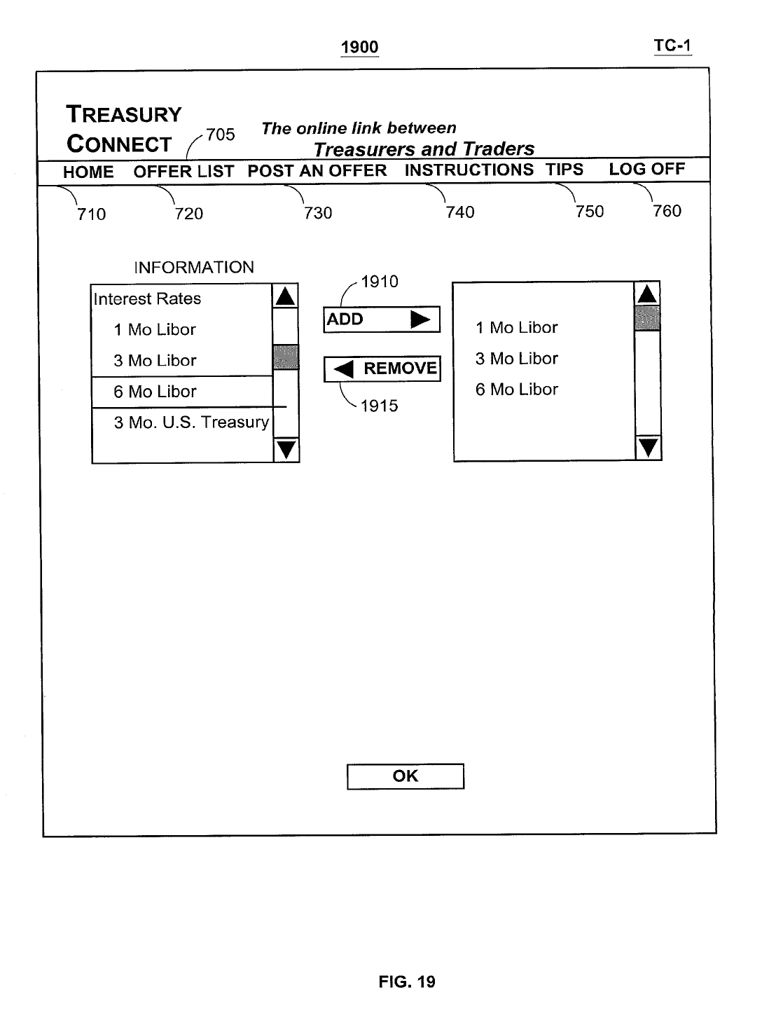

FIG. 19 shows an illustrative page 1900 that the system may provide in response to a user indicating a desire to specialize the user's pages (e.g., by selecting ling 797 of FIG. 7). In this example, the user may select swap parameters, invitee parameters, and other information for inclusion into the user's pages. The user may add information by, for example, highlighting the desired information and pushing button 1910. The user may remove information by, for example, highlighting the desired information and pushing button 1915. The user may indicate that the user has finished specializing the user's pages by, for example, pressing button 1920.

Thus, systems and methods for providing electronic trading are provided. Users may offer and bid on derivatives using an electronic auction. While some features of the present invention have been described in the context of a swap trading system, they may be applied to other trading systems such as to systems for trading stocks, bonds, shares in mutual funds, options, or other equities, debt instruments, derivatives, or any other suitable financial asset or liability. One skilled in the art will appreciate that the present invention can be practiced by other than the described embodiments, which are presented for purposes of illustration and not of limitation, and the present invention is limited only by the claims which follow.

What is claimed is:

1. A method for allowing users of an electronic swap trading system to obtain bids on swaps in an electronic swap auction, comprising:
providing a user with an opportunity to indicate terms for a swap using an electronic swap term sheet; and
providing an electronic auction for the swap having the terms indicated by the user using the electronic swap term sheet.

2. The method defined in claim 1 further comprising:
providing a user with an opportunity to indicate at least one invitee user from a plurality of users;
electronically inviting the at least one invitee user to participate in the auction for the swap; and
providing the at least one invitee user with an opportunity to participate in the auction for the swap.

3. The method defined in claim 2 wherein electronically inviting the at least one invitee user to participate in the auction for the swap comprises sending the invitee user an e-mail message that indicates an invitation to participate in the auction.

4. The method defined in claim 3 wherein sending the invitee user an e-mail message that indicates an invitation to participate in the auction comprises sending the invitee user an e-mail that contains an Internet link to an auctions page for the auction.

5. The method defined in claim 2 wherein electronically inviting the at least one invitee user to participate in the auction for the swap comprises automatically paging the invitee user to participate in the auction.

6. The method defined in claim 2 wherein:
the auction is an open auction; and
providing the at least one invitee user with an opportunity to participate in the auction for the swap comprises displaying pending bids for the swap.

7. The method defined in claim 6 wherein:
the pending bids are made by the at least one invitee user; and
displaying pending bids for the swap comprises keeping the identity of the one invitee user secret from another invitee user.

8. The method defined in claim 2 wherein:
the auction has a best bid; and
providing the at least one invitee user with an opportunity to participate in the auction for the swap comprises providing the at least one invitee user with an opportunity to beat the best bid using a single action.

9. The method defined in claim 2 wherein providing the at least one invitee user with an opportunity to participate in the auction for the swap comprises providing the at least one invitee user with an opportunity to retract a bid.

10. The method defined in claim 2 wherein providing the at least one invitee user with an opportunity to participate in the auction for the swap comprises providing the at least one invitee user with an opportunity to bid by proxy.

11. The method defined in claim 1 further comprising providing the user with an opportunity to indicate a desired auction from a plurality of auctions.

12. The method defined in claim 1 further comprising providing the user with an opportunity to approve the auction with the terms indicated by the user using the electronic swap term sheet.

13. The method defined in claim 1 wherein providing an electronic auction for the swap as indicated by the user using the electronic swap term sheet comprises providing the user with an opportunity to monitor bids.

14. The method defined in claim 1 wherein providing an electronic auction for the swap as indicated by the user using the electronic swap term sheet comprises providing the user with an opportunity to accept a bid.

15. The method defined in claim 1 wherein:
providing a user with an opportunity to indicate swap terms for a swap using an electronic swap term sheet comprises providing a user with an opportunity to indicate swap terms for a swap using a specialized electronic swap term sheet having a plurality of potential swap terms, wherein the potential swap terms are included in the electronic swap term sheet based on the user's preferences; and
providing an auction for a swap as indicated by the user using the electronic swap term sheet comprises providing an auction for a swap as indicated by the user using the specialized electronic swap term sheet.

16. The method defined in claim 15 wherein providing a user with an opportunity to indicate swap terms for a swap using a specialized electronic swap term sheet having a plurality of potential swap terms comprises providing a user with an opportunity to indicate swap terms for a swap using a specialized electronic swap term sheet having at least one specialized potential swap term selected from the group of swap terms consisting of: interest rates, equity indexes, currencies, amortization schedules, call schedules, and floating rate indices.

17. The method defined in claim 1 wherein:
the electronic auction has a first predetermined time period during which bids may be made electronically by users, wherein the first predetermined time period has an end; and
the method further comprises extending the first predetermined time period during which bids may be made electronically by users in response to at least one bid being made by a user during a second predetermined time period within the end of the first predetermined time period.

18. The method defined in claim 1 further comprising providing at least one bidding user with an opportunity to participate in the auction for the swap.

19. The method defined in claim 18 wherein the method further comprises displaying pending bids for the swap.

20. The method defined in claim 19 wherein displaying pending bids for the swap comprises keeping identities of bidding users secret.

21. The method defined in claim 18 wherein:
the auction has a best bid; and
providing the at least one bidding user with an opportunity to participate in the auction for the swap comprises providing the at least one bidding user with an opportunity to beat the best bid using a single action.

22. The method defined in claim 18 wherein providing the at least one bidding user with an opportunity to participate in the auction for the swap comprises providing the at least one bidding user with an opportunity to retract a bid.

23. The method defined in claim 18 wherein providing the at least one bidding user with an opportunity to participate in the auction for the swap comprises providing the at least one bidding user with an opportunity to bid by proxy.

24. The method defined in claim 1 further comprising providing the user with an opportunity to confirm a swap with a bidding user.

25. The method defined in claim 24 wherein providing the user with an opportunity to confirm a swap with a bidding user comprises providing the user with an opportunity to confirm a swap by e-mail with the bidding user.

26. The method defined in claim 24 wherein providing the user with an opportunity to confirm a swap with a bidding user comprises providing the user with an opportunity to confirm a swap using computer-based telephony.

27. The method defined in claim 18 further comprising providing instructions to an electronic commerce system for the electronic exchange of funds from the user to a bidding user in accordance with the terms of the swap.

28. The method defined in claim 1 further comprising downloading the indicated swap terms to a user's risk management or back office system to provide for straight-through processing of the swap by the user's risk management or back office system.

29. The method defined in claim 1 wherein providing a user with an opportunity to indicate terms for a swap using an electronic swap term sheet comprises providing a user with an electronic swap term sheet page.

30. The method defined in claim 1 wherein providing a user with an opportunity to indicate terms for a swap using an electronic swap term sheet comprises providing a user with an opportunity to indicate terms for a swap selected from the group of swaps consisting of: interest rate swaps, equity swaps, currency swaps, zero coupon swaps, basis-rate swaps, caps, floors, and collars.

31. The method defined in claim 1 wherein providing an electronic auction for the swap comprises providing an electronic best-bid-wins auction for the swap having the terms indicated by the user using the electronic swap term sheet.

32. The method defined in claim 1 wherein providing an electronic auction for the swap comprises providing an electronic English-style auction for the swap having the terms indicated by the user using the electronic swap term sheet.

33. The method defined in claim 1 wherein providing an electronic auction for the swap comprises providing an electronic Dutch-style auction for the swap having the terms indicated by the user using the electronic swap term sheet.

34. The method defined in claim 1 wherein providing an electronic auction for the swap comprises providing an electronic closed auction for the swap having the terms indicated by the user using the electronic swap term sheet.

35. A method for bidding on swaps using the Internet comprising:
accessing an auction page for a swap;
placing a bid on the swap using the auction page; and
confirming the swap when the auction is complete.

36. The method defined in claim 35 wherein:
the method further comprises receiving an invitation to access the auction page for the swap; and
accessing an auction page for the swap comprises accessing the auction page in response to receiving the invitation.

37. The method defined in claim 35 wherein placing a bid on the swap using the auction page comprises placing a proxy bid on the swap using the auction page.

38. The method defined in claim 35 wherein confirming the swap when the auction is complete comprises electronically confirming the swap when the auction is complete.

39. The method defined in claim 35 further comprising:
providing the terms to a risk management or back office system;
receiving a bid calculated by the risk management or back office system.

40. A method for allowing users of an on-line swap trading system to electronically effect swap trades comprising:
providing a first user with an opportunity to indicate terms of a swap using a swap term sheet page;
providing the first user with an opportunity to invite at least one invitee user to bid on the swap in a auction;
electronically inviting the at least one invitee user to participate in the auction;
providing the at least one invitee user with an opportunity to place a bid on the swap in the auction;
completing the auction;
identifying a particular one of the at least one invitee user;
providing the first user and the particular one of the at least one invitee user with an opportunity to confirm the swap; and
providing the indicated swap terms to the user's risk management or back office system to provide for straight-through processing of the swap by the user's risk management or back office system.

41. The method defined in claim 40 wherein providing the at least one invitee user with an opportunity to place a bid on the swap in the auction comprises:
providing the terms to a risk management or back office system of an invitee user; and
receiving a bid calculated by the risk management or back office system of the invitee user.

42. A method for allowing users of an electronic derivatives trading system to bid on derivatives in an electronic derivatives auction, comprising:
providing an electronic auction for a derivative;
providing to each user of a plurality of users an opportunity to electronically bid on the derivative in the auction; and
providing to each user of the plurality of users the bids of the other users while keeping the identities of the other users secret.

43. The method defined in claim 42 wherein providing to each user of a plurality of users an opportunity to electronically bid on the derivative in the auction comprises providing to each user of a plurality of users an opportunity to electronically bid on the derivative over the Internet.

44. The method defined in claim 42 wherein:
providing an electronic auction for a derivative comprises providing an electronic auction for a swap; and
providing to each user of a plurality of users an opportunity to electronically bid on the derivative in the auction comprises providing to each user of a plurality of users an opportunity to electronically bid on the swap.

45. A method for allowing users of an electronic trading system to bid on financial instruments in an electronic auction, comprising:
providing an electronic auction for a financial instrument;
providing to each user of a plurality of users an opportunity to electronically bid on the financial instrument in the auction;
completing the auction; and
downloading a winning bid of the auction to a risk management or back office system of one user of the plurality of users.

46. The method defined in claim 45 wherein:
providing an electronic auction for a financial instrument comprises providing an electronic auction for a swap; and
providing to each user of a plurality of users an opportunity to electronically bid on the financial instrument in the auction comprises providing to each user of a plurality of users an opportunity to electronically bid on the swap.

47. The method defined in claim 45 wherein providing to each user of a plurality of users an opportunity to electronically bid on the financial instrument in the auction comprises providing to each user of a plurality of users an opportunity to electronically bid on the financial instrument over the Internet.

48. A method for allowing users of an electronic trading system to obtain bids on financial instruments in an electronic auction, comprising:
providing a user with an opportunity to indicate terms for an offer for a financial instrument using a specialized electronic term sheet; and
providing an electronic auction for the financial instrument having the offer terms indicated by the user using the specialized electronic term sheet.

49. The method defined in claim 48 wherein providing an electronic auction for the financial instrument having the offer terms indicated by the user using the specialized electronic term sheet comprises providing an electronic auction over the Internet.

50. A method for allowing users of an electronic trading system to obtain bids on financial instruments comprising:
providing a user with an opportunity to indicate terms for an offer for a financial instrument;
providing the user with an opportunity to indicate at least one other user whom the user wishes to invite to participate in an electronic auction for the financial instrument;
electronically inviting the indicated at least one other user to participate in the electronic auction; and
providing the electronic auction for the financial instrument having the offer terms indicated by the user.

51. The method defined in claim 50 wherein providing the electronic auction for the financial instrument having the offer terms indicated by the user comprises providing the electronic auction over the Internet.

52. The method defined in claim 50 wherein electronically inviting the at least one other user to participate in the electronic auction comprises sending the at least one other user an e-mail message that indicates an invitation to participate in the auction.

53. The method defined in claim 50 wherein electronically inviting the at least one other user to participate in the electronic auction comprises sending the at least one other user an e-mail message that contains an Internet link to an auctions page for the auction.

54. The method defined in claim 50 wherein electronically inviting the at least one other user to participate in the electronic auction comprises automatically paging the at least one other user to participate in the auction.

55. The method defined in claim 50 wherein providing the user with an opportunity to indicate at least one other user whom the user wishes to invite to participate in an electronic auction for the financial instrument comprises providing the user with an opportunity to indicate at least one other user using a specialized list of users.

56. A method for allowing users of an electronic trading system to bid on financial instruments comprising:
providing an electronic auction for a financial instrument offered by an offering user;
providing to each bidding user of a plurality of bidding users an opportunity to electronically bid on the financial instrument in the auction; and
creating a binding agreement to trade the financial instrument between the offering user and a bidding user of the plurality of bidding users by completing the auction.

57. A method for allowing users of an electronic trading system to bid on financial instruments, comprising:
providing an electronic auction for a financial instrument offered by an offering user;
providing to each bidding user of a plurality of bidding users an opportunity to electronically bid on the financial instrument in the auction; and
creating a binding agreement to trade the financial instrument between the offering user and a bidding user of the plurality of bidding users by providing the offering user and a bidding user an opportunity to electronically confirm the trade of the financial instrument.

58. A method for allowing users of an electronic trading system to obtain bids on derivatives in an electronic derivatives auction, comprising:
providing an offering user with an opportunity to indicate terms for an offer for a derivative;
providing a bidding user with an opportunity to bid on the derivative in an electronic derivatives auction based on the offer; and
electronically transferring funds between the offering user and the bidding user in accordance with the bid and the offer.

59. An electronic trading system for allowing users to obtain bids on swaps in an electronic swap auction, comprising:
a server configured to receive terms for a swap and to provide an electronic auction for the swap; and
an access device configured to: (1) provide a user with an opportunity to indicate terms for the swap using an electronic swap term sheet, and (2) provide the user with access to the electronic auction.

60. The system defined in claim 59 wherein:
the access device is further configured to provide the user with an opportunity to indicate at least one invitee user from a plurality of users;
the server is configured to send an electronic invitation to the at least one invitee user to participate in the auction for the swap; and
the system further comprises a second access device configured to provide the at least one invitee user with an opportunity to participate in the auction for the swap.

61. The system defined in claim 60 wherein the electronic invitation is an e-mail message that indicates an invitation to participate in the auction.

62. The system defined in claim 60 wherein the electronic invitation is an e-mail that contains an Internet link to an auctions page for the auction.

63. The system defined in claim 60 wherein:
the system further comprises a paging/dialing system; and
the server is further configured to provide instructions to the paging/dialing system to automatically page the invitee user to participate in the auction.

64. The system defined in claim 60 wherein:
the auction is an open auction;
the server is further configured to provide pending bids to the second access device; and
the second access device is further configured to display the pending bids for the swap.

65. The system defined in claim 64 wherein:
the pending bids are made by the at least one invitee user;
the server is further configured to provide pending bids to the second access device while keeping the identity of the one invitee user secret; and
the second access device is further configured to display pending bids for the swap comprises keeping the identity of the one invitee user secret from another invitee user.

66. The system defined in claim 60 wherein:
the auction has a best bid; and
the second access device is further configured to provide the at least one invitee user with an opportunity to beat the best bid using a single action.

67. The system defined in claim 60 wherein:
the second access device is further configured to provide the at least one invitee user with an opportunity to retract a bid; and
the server is further configured to retract the bid from the auction.

68. The system defined in claim 60 wherein the second access device is further configured to provide the at least one invitee user with an opportunity to bid by proxy.

69. The system defined in claim 59 wherein the access device is further configured to provide the user with an opportunity to indicate a desired auction from a plurality of auctions.

70. The system defined in claim 59 wherein the access device is further configured to provide the user with an opportunity to approve the auction with the terms indicated by the user using the electronic swap term sheet.

71. The system defined in claim 59 wherein:
the server is further configured to provide bids to the access device as bids are posted; and
the access device is further configured to provide the user with an opportunity to monitor bids.

72. The system defined in claim 59 wherein the access device is further configured to provide the user with an opportunity to accept a bid.

73. The system defined in claim 59 wherein:
the access device is further configured to: (1) provide a specialized electronic term sheet to the user, wherein the specialized electronic term sheet a plurality of potential swap terms and the potential swap terms are included in the electronic swap term sheet based on the user's preferences, and (2) provide the user with an opportunity to indicate swap terms for a swap using the specialized electronic swap term sheet; and
the server is further configured to provide the auction for a swap as indicated by the user using the specialized electronic swap term sheet.

74. The system defined in claim 73 wherein the specialized potential swap terms are selected from the group of swap terms consisting of: interest rates, equity indexes, currencies, amortization schedules, call schedules, and floating rate indices.

75. The system defined in claim 59 wherein:
the electronic auction has a first predetermined time period during which bids may be made electronically by users, wherein the first predetermined time period has an end; and
the server is further configured to extend the first predetermined time period during which bids may be made electronically by users in response to at least one bid being made by a user during a second predetermined time period within the end of the first predetermined time period.

76. The system defined in claim 59 further comprising at least one second access device configured to provide a bidding user of a plurality of bidding users with an opportunity to participate in the auction for the swap.

77. The system defined in claim 76 wherein:
the server is further configured to provide pending bids to the second access device; and
the second access device is further configured to receive the pending bids.

78. The system defined in claim 76 wherein:
the server is further configured to provide pending bids to the second access device while keeping the identities of each bidding user secret from each bidding user; and
each second access device is further configured to display pending bids for the swap while keeping identities of other bidding users secret to each bidding user.

79. The system defined in claim 78 wherein:
the auction has a best bid; and
each second access device is further configured to provide each bidding user with an opportunity to beat the best bid using a single action.

80. The system defined in claim 78 wherein each second access device is further configured to provide a bidding user with an opportunity to retract a bid.

81. The system defined in claim 78 wherein each second access device is further configured to provide a bidding user with an opportunity to bid by proxy.

82. The system defined in claim 59 wherein the access device is further configured to provide the user with an opportunity to confirm a swap with a bidding user.

83. The system defined in claim 59 wherein the access device is further configured to provide the user with an opportunity to confirm a swap by e-mail with the bidding user.

84. The system defined in claim 59 wherein the access device is further configured to provide the user with an opportunity to confirm a swap using computer-based telephony.

85. The system defined in claim 59 wherein the server is further configured to provide instructions to an electronic commerce system for the electronic exchange of funds from the user to a bidding user in accordance with the terms of the swap.

86. The system defined in claim 59 wherein the access device is further configured to the indicated swap terms to a user's risk management or back office system to provide for straight-through processing of the swap by the user's risk management or back office system.

87. The system defined in claim 59 wherein the access device is Internet enabled and further configured to provide a user with an electronic swap term sheet page.

88. The system defined in claim 59 wherein the terms for a swap are selected from the group of swaps consisting of: interest rate swaps, equity swaps, currency swaps, zero coupon swaps, basis-rate swaps, caps, floors, and collars.

89. The system defined in claim 59 wherein the server is further configured to provide an electronic best-bid-wins auction for the swap having the terms indicated by the user using the electronic swap term sheet.

90. The system defined in claim 59 wherein the server is further configured to provide an electronic English-style auction for the swap having the terms indicated by the user using the electronic swap term sheet.

91. The system defined in claim 59 wherein the server is further configured to provide an electronic Dutch-style auction for the swap having the terms indicated by the user using the electronic swap term sheet.

92. The system defined in claim 59 wherein the server is further configured to provide an electronic closed auction for the swap having the terms indicated by the user using the electronic swap term sheet.

93. An electronic trading system for allowing users to bid on swaps using the Internet comprising:
a server;
an Internet enabled access device configured to:
download an auction page for a swap from the server;
place a bid on the swap using the auction page;
provide the user with an opportunity to provide the bid to the server; and
provide the user with an opportunity to electronically confirm the swap when the auction is complete.

94. The system defined in claim 93 wherein the access device is further configured to:
receive an invitation to access the auction page for the swap; and
provide the invitation to the user.

95. The system defined in claim 93 wherein the access device is further configured to provide the user with an opportunity to place a proxy bid on the swap using the auction page.

96. The system defined in claim 93 wherein the access device is further configured to electronically confirm the swap when the auction is complete.

97. The system defined in claim 93 wherein the access device is further configured to:
provide the terms to a risk management or back office system; and
receive a bid calculated by the risk management or back office system.

98. An electronic trading system for allowing users to electronically effect swap trades comprising:
a first access device configured to:
provide a first user with an opportunity to indicate terms of a swap using a swap term sheet page;
provide the first user with an opportunity to invite at least one invitee user to bid on the swap in a auction; and
electronically invite the at least one invitee user to participate in the auction;
a second access device configured to
provide the at least one invitee user with an opportunity to place a bid on the swap in the auction;
a server configured to provide the first user and the particular one of the at least one invitee users with an opportunity to confirm the swap; and
wherein the first and second access devices are further configured to provide the indicated swap terms to the a risk management or back office system to provide for straight-through processing of the swap by the risk management or back office system.

99. The system defined in claim 98 wherein the second access device is further configured to: (1) provide the terms to a risk management or back office system of an invitee user, (2) receive a bid calculated by the risk management or back office system of the invitee user, and (3) provide the bid to the server.

100. An electronic trading system for allowing users to bid on derivatives in an electronic derivatives auction, comprising:
a server configured to provide an electronic auction for a derivative; and
a plurality of access devices each configured to: (1) provide to each user of a plurality of users an opportunity to electronically bid on the derivative in the auction, and (2) provide to each user of the plurality of users the bids of the other users while keeping the identities of the other users secret.

101. The system defined in claim 100 wherein each access device is Internet enabled and configured to provide to each user of the plurality of users an opportunity to electronically bid on the derivative over the Internet.

102. The system defined in claim 100 wherein the derivative is a swap.

103. An electronic trading system for allowing users to bid on financial instruments in an electronic auction, comprising:
a server configured to provide an electronic auction for a financial instrument;
a plurality of access devices wherein each access device is configured to: (1) provide to each user of a plurality of users an opportunity to electronically bid on the financial instrument in the auction, (2) automatically complete the auction, and (3) download a winning bid of the auction to a risk management or back office system.

104. The system defined in claim 103 wherein:
the financial instrument is a swap; and
each access device is further configured to provide to each user of a plurality of users an opportunity to electronically bid on the swap.

105. The system defined in claim 103 wherein each access device is further configured to electronically bid on the financial instrument over the Internet.

106. An electronic trading system for allowing users to obtain bids on financial instruments in an electronic auction, comprising:
a server configured to provide an electronic auction for a financial instrument; and
an access device configured to provide a user with an opportunity to indicate the terms using a specialized electronic term sheet.

107. The system defined in claim 106 wherein
the server is an Internet and application server; and
the access device is Internet enabled.

108. An electronic trading system for allowing users to obtain bids on financial instruments comprising:
a server;
an access device configured to:
provide a user with an opportunity to indicate terms for an offer for a financial instrument;
provide the user with an opportunity to indicate at least one other user whom the user wishes to invite to participate in an electronic auction for the financial instrument;
provide an electronic invitation to the indicated at least one other user to participate in the electronic auction; and
wherein the server is further configured to provide the electronic auction for the financial instrument to the access device having the offer terms indicated by the user.

109. The system defined in claim 108 wherein:
the server is an Internet and application server; and
the access device is Internet enabled.

110. The system defined in claim 108 wherein the electronic invitation is an e-mail message that indicates an invitation to participate in the auction.

111. The system defined in claim 108 wherein the electronic invitation is an e-mail message that contains an Internet link to an auctions page for the auction.

112. The system defined in claim 108 wherein:
the system further comprises a paging/dialing system; and
the server is further configured to instruct the paging/dialing system to automatically page the at least one other user to participate in the auction.

113. The system defined in claim 108 wherein the access device is further configured to provide the user with an opportunity to indicate at least one other user using a specialized list of users.

114. An electronic trading system for allowing users to bid on financial instruments comprising:
a first access device configured to provide an offering user with an opportunity to indicate a financial instrument to trade;
a server configured to provide an electronic auction for the financial instrument;
a plurality of second access devices configured to provide to each bidding user of a plurality of bidding users an opportunity to electronically bid on the financial instrument in the auction; and
wherein the first and second access devices provide the offering user and a bidding user of the plurality of bidding users with an opportunity to create a binding agreement to trade the financial instrument by completing the auction.

115. An electronic trading system for allowing users to bid on financial instruments, comprising:
a first access device configured to provide an offering user with an opportunity to indicate a financial instrument to trade;
a server configured to provide an electronic auction for a financial instrument;
a plurality of second access devices configured to provide to each bidding user of a plurality of bidding users an opportunity to electronically bid on the financial instrument in the auction; and
wherein the first and second access devices provide the offering user and a bidding user of the plurality of bidding users with an opportunity to create a binding agreement to trade the financial instrument by providing the offering user and a bidding user an opportunity to electronically confirm the trade of the financial instrument.

116. An electronic trading system for allowing users to obtain bids on financial instruments in an electronic auction, comprising:
a first access device configured to provide an offering user with an opportunity to indicate terms for an offer for a financial instrument;
a second access device configured to provide a bidding user with an opportunity to bid on the financial instrument in an electronic auction based on the offer; and
an electronic commerce system configured to electronically transfer funds between the offering user and the bidding user in accordance with the bid and the offer.

117. An electronic swap trading system for allowing users to obtain bids on swaps in an electronic swap auction, comprising:
means for providing a user with an opportunity to indicate terms for a swap using an electronic swap term sheet; and
means for providing an electronic auction for the swap having the terms indicated by the user using the electronic swap term sheet.

118. A system for allowing users to bid on swaps using the Internet comprising:
means for accessing an auction page for a swap;
means for placing a bid on the swap using the auction page; and
means for confirming the swap when the auction is complete.

119. An on-line swap trading system for allowing users to electronically effect swap trades comprising:
means for providing a first user with an opportunity to indicate terms of a swap using a swap term sheet page;
means for providing the first user with an opportunity to invite at least one invitee user to bid on the swap in a auction;
means for electronically inviting the at least one invitee user to participate in the auction;
means for providing the at least one invitee user with an opportunity to place a bid on the swap in the auction;
means for completing the auction;
means for identifying a particular one of the at least one invitee user;
means for providing the first user and the particular one of the at least one invitee user with an opportunity to confirm the swap; and
means for providing the indicated swap terms to the user's risk management or back office system to provide for straight-through processing of the swap by the user's risk management or back office system.

120. An electronic derivatives trading system for allowing users to bid on derivatives in an electronic derivatives auction, comprising:
means for providing an electronic auction for a derivative;
means for providing to each user of a plurality of users an opportunity to electronically bid on the derivative in the auction; and
means for providing to each user of the plurality of users the bids of the other users while keeping the identities of the other users secret.

121. An electronic trading system for allowing users to bid on financial instruments in an electronic auction, comprising:
means for providing an electronic auction for a financial instrument;
means for providing to each user of a plurality of users an opportunity to electronically bid on the financial instrument in the auction;
means for completing the auction; and
means for downloading a winning bid of the auction to a risk management or back office system of one user of the plurality of users.

122. An electronic trading system for allowing users to obtain bids on financial instruments in an electronic auction, comprising:
means for providing a user with an opportunity to indicate terms for an offer for a financial instrument using a specialized electronic term sheet; and
means for providing an electronic auction for the financial instrument having the offer terms indicated by the user using the specialized electronic term sheet.

123. An electronic trading system for allowing users to obtain bids on financial instruments comprising:
means for providing a user with an opportunity to indicate terms for an offer for a financial instrument;
means for providing the user with an opportunity to indicate at least one other user whom the user wishes to invite to participate in an electronic auction for the financial instrument;
means for electronically inviting the indicated at least one other user to participate in the electronic auction; and
means for providing the electronic auction for the financial instrument having the offer terms indicated by the user.

124. An electronic trading system for allowing users to bid on financial instruments comprising:
means for providing an electronic auction for a financial instrument offered by an offering user;
means for providing to each bidding user of a plurality of bidding users an opportunity to electronically bid on the financial instrument in the auction; and
means for creating a binding agreement to trade the financial instrument between the offering user and a bidding user of the plurality of bidding users by completing the auction.

125. An electronic trading system for allowing users to bid on financial instruments, comprising:
means for providing an electronic auction for a financial instrument offered by an offering user;
means for providing to each bidding user of a plurality of bidding users an opportunity to electronically bid on the financial instrument in the auction; and
means for creating a binding agreement to trade the financial instrument between the offering user and a bidding user of the plurality of bidding users by providing the offering user and a bidding user an opportunity to electronically confirm the trade of the financial instrument.

126. An electronic trading system for allowing users to obtain bids on derivatives in an electronic derivatives auction, comprising:
means for providing an offering user with an opportunity to indicate terms for an offer for a derivative;
means for providing a bidding user with an opportunity to bid on the derivative in an electronic derivatives auction based on the offer; and
means for electronically transferring funds between the offering user and the bidding user in accordance with the bid and the offer.
